(19) United States
(12) Patent Application Publication
(10) Pub. No.: US 2014/0084884 A1
(43) Pub. Date: Mar. 27, 2014

(54) LC SWITCHING REGULATORS

(71) Applicant: Jong J. Lee, Pleasanton, CA (US)

(72) Inventor: Jong J. Lee, Pleasanton, CA (US)

(21) Appl. No.: 13/932,874

(22) Filed: Jul. 1, 2013

Related U.S. Application Data
(60) Provisional application No. 61/668,454, filed on Jul. 6, 2012.

(51) Int. Cl. H02M 3/158

(52) U.S. Cl. CPC H02M 3/158
USPC 323/271

(57) ABSTRACT

A switching regulator is used in a circuit having an inductor and one or more switches that control charges applied to the inductor from an input voltage source. The switching regulator has an error amplifier configured to generate an error voltage signal by amplifying a difference between a feedback output voltage and a reference voltage, an inductor current emulation circuit configured to generate an emulated inductor current signal that emulates an inductor current that flows through the inductor, an error voltage comparator configured to generate a timing pulse signal by comparing the error voltage signal to the emulated inductor current signal and a controller configured to modulate at least one switching intervals of the switches by control signals generated based on the timing pulse signal.

### PRIORITY CLAIMS

This application claims the benefit of priority of commonly-assigned, co-pending U.S. Provisional application Ser. No. 61/668,454, to Jong J. Lee, entitled “DESIGN OF LC SWITCHING REGULATORS”, filed Jul. 6, 2012, the entire disclosure of which is herein incorporated by reference.

### FIELD OF THE DISCLOSURE

The present disclosure is related to electronic circuits, and, more particularly, to LC switching regulators.

### BACKGROUND

Electronic voltage regulators are found in devices such as computers, communication equipments, and cellular phones where they regulate the DC voltages used by the processor and other electronic elements. Conventionally, linear regulators are commonly used because they are easy to use and cheap to build. However, switching regulators have become the design of choice over linear regulators for most applications because they offer significant advantages on power-conversion efficiency. Higher efficiency provides longer usage time of battery-powered electronic devices and less heat to be dissipated for high powered electronic equipments. Generally, the higher efficiency of switching regulators is resulted because low loss components such as capacitors, inductors, transformers and power switches, are employed in switching regulators.

Switching regulators have become the design of choice over linear regulators because they offer significant advantages on efficiency, and avoid most of the power dissipation problems associated with linear regulators. Generally, switching regulators are configured to convert an input voltage at one level to an output voltage at a desired level, and maintain a constant output voltage level. Low loss components such as capacitors, inductors, transformers and power switches, are employed in switching regulators.

A switching regulator with the help of a power switch operates by taking small chucks of energy from the input voltage source and transferring them to the output in discrete packets. Specifically, when the switch is turned on, energy is applied to an inductor and the current through the inductor may build up. When the power switch is turned off, the voltage across the inductor reverses and charges are transferred to an output capacitor and the load. When the power switch is on again, the output capacitor discharges and may maintain a relatively constant output voltage. The duty cycle of the switch may control the voltage level of the output voltage.

A switching regulator usually includes a feedback control circuit in order to stabilize the voltage regulating system. The feedback control circuit is required to minimize the regulating voltage error and to maximize its regulating response for output load current change, input voltage change, and other regulation disturbances on the system. Examples of feedback control circuits include voltage-mode feedback and current-mode feedback. The voltage-mode feedback circuit makes the system stable with the phase compensation circuit built with resistors, capacitors and amplifiers. The current-mode feedback circuit makes the system stable by modulating the duty cycle applied to the power switches based on the sensed inductor current signal.

A switching regulator can be configured to step up the input voltage or step down the input voltage or both. Specifically, a buck switching regulator as shown FIG. 1(a), also called a “buck converter,” steps down the input voltage while a boost switching regulator as shown in FIG. 1(b), also called a “boost converter,” steps up the input voltage. A buck-boost switching regulator as shown in FIG. 1(c), or buck-boost converter, provides both step-up and step-down functions.

It is within this context that the present invention arises.

### SUMMARY

Aspects of the present disclosure provide a switching regulator having an inductor and at least one switches that control charges applied to the inductor from an input voltage source. The switching regulator comprises an error amplifier configured to generate an error voltage signal by amplifying a difference between a feedback output voltage and a reference voltage, an inductor current emulation circuit configured to generate an emulated inductor current signal that emulates an inductor current that flows through the inductor, an error voltage comparator configured to generate a timing pulse signal by comparing the error voltage signal to the emulated inductor current signal and a controller configured to modulate at least one switching intervals of the switches by control signals generated based on the timing pulse signal.

Additional aspects of the present disclosure describe a controller provided in a switching regulator. The controller comprises an oscillator and clock generator configured to generate clock signals, wherein the generator can be stopped or resumed for its oscillation; a first state machine configured to control on/off states of the switches and configured to control the oscillator and clock generator; a second state machine configured to execute a sequence of instructions in response to flag signals to direct the switching regulator through a sequence of operational modes; a datapath configured to generate end signals to end the switching intervals of the switches; a digital reference voltage circuit configured to generate the reference voltage and configured to ramp up or ramp down the reference voltage; and a flag logic circuit configured to interface flag signals to at least the second state machine.

According to other aspects of the present disclosure, a controller provided in a switching regulator modulates both the switching intervals (T1 and T2) based on a timing pulse signal wherein the error voltage signal crosses a centroid point of the rising and falling saw-tooth edge of the emulated inductor current signal in each switching interval and wherein a switching period which equals to T1+T2 is regulated. The timing pulse signal is generated from a difference between an error voltage signal and an emulated inductor current signal.

### BRIEF DESCRIPTION OF THE DRAWINGS

FIGS. 1a-1c are circuit diagrams respectively illustrating a conventional buck switching regulator, a boost switching regulator and a buck-boost switching regulator.

FIGS. 2a-2c are circuit diagrams respectively illustrating a buck switching regulator, a boost switching regulator and a buck-boost switching regulator in accordance with embodiments of the present disclosure.

FIG. 3 is a block circuit diagram illustrating an example V/T converter incorporated in a switching regulator in accordance with one embodiment of the present disclosure.

FIGS. 4A-4C are three examples of an error amplifier that may be incorporated in a switching regulator in accordance with the present disclosure.

FIG. 5 is a simplified circuit diagram illustrating an example V/T converter incorporated in a switching regulator in accordance with one embodiment of the present disclosure.

FIG. 6 is an inductor current waveform of a LC switching regulator.

FIG. 7a is a circuit diagram illustrating an example inductor current emulation circuit incorporated in a switching regulator in accordance with one embodiment of the present disclosure.

FIG. 7b is a waveform of an emulating inductor current signal from FIG. 7a.

FIGS. 8a-8d show example waveforms of an inductor current signal and an emulated inductor current signal.

FIG. 9 is a circuit diagram illustrating an example inductor current emulation circuit incorporated in a switching regulator in accordance with one embodiment of the present disclosure.

FIG. 10 is a circuit diagram illustrating an example inductor current emulation circuit incorporated in a switching regulator in accordance with one embodiment of the present disclosure.

FIG. 11 is a Bode plot of the transfer impedance function.

FIG. 12 is a diagram illustrating an example error comparator incorporated in a switching regulator in accordance with one embodiment of the present disclosure.

FIG. 13 is a simplified diagram illustrating an example V/T converter incorporated in a switching regulator in accordance with one embodiment of the present disclosure.

FIG. 14 is a Bode plot of the transfer function.

FIG. 15 is a Bode plot of the open loop transfer function of a buck switching regulator in accordance with one embodiment of the present disclosure.

FIG. 16 is a waveform illustrating relationships among the output timing pulse Cmp, the error voltage signal V_{E}, the emulated inductor current signal Vx and the switching intervals T1 and T2.

FIG. 17 shows waveforms of an emulated inductor current signal with slope modification.

FIG. 18 is a diagram illustrating a V/T converter with an example slope compensation circuit in accordance with one embodiment of the present disclosure.

FIG. 19 is a diagram illustrating a V/T converter with an example slope compensation circuit in accordance with one embodiment of the present disclosure.

FIG. 20 is a diagram illustrating a V/T converter with an example slope compensation circuit in accordance with one embodiment of the present disclosure.

FIG. 21 is a block diagram illustrating a digital controller in accordance with one embodiment of the present disclosure.

FIG. 22 is a logic diagram illustrating an oscillator and clock generator provided in a digital controller in accordance with one embodiment of the present disclosure.

FIG. 23 is a diagram illustrating an oscillator and clock generator provided in a digital controller in accordance with one embodiment of the present disclosure.

FIG. 24 is a diagram illustrating relationship among timing signals generated by the oscillator and clock generator of FIG. 23.

FIG. 25 is a block diagram illustrating nSTATE machine provided in a digital controller in accordance with one embodiment of the present disclosure.

FIGS. 26a-26c are state transition diagrams of the nSTATE machine in FIG. 25.

FIG. 27 is a block diagram illustrating uSTATE machine provided in a digital controller in accordance with one embodiment of the present disclosure.

FIG. 28 is a state transition diagram of the uSTATE machine in FIG. 27.

FIG. 29 is a state transition diagram of the uSTATE machine in FIG. 27.

FIG. 30 is a block diagram illustrating a datapath provided in a digital controller in accordance with one embodiment of the present disclosure.

FIG. 31 is a block diagram illustrating a digital reference voltage block provided in a digital controller in accordance with one embodiment of the present disclosure.

FIG. 32 is a block diagram illustrating a flag logic, uSTATE machine, digital reference voltage block and self-test block provided in a digital controller in accordance with one embodiment of the present disclosure.

FIG. 33 is a block diagram illustrating an oscillation and clock generator, nSTATE machine and datapath provided in a digital controller in accordance with one embodiment of the present disclosure.

FIG. 34 is a diagram illustrating relationship among timing signals of FIG. 33.

FIG. 35 is a flag logic block provided in a digital controller in accordance with one embodiment of the present disclosure.

FIG. 36 is a block diagram illustrating a self-test block provided in a digital controller in accordance with one embodiment of the present disclosure.

FIGS. 37a-37d illustrates four error tracking methods in accordance with embodiments of the present disclosure.

FIG. 38 is a circuit diagram implementing the error tracking method of FIG. 37a.

FIG. 39 illustrates the error tracking method of FIG. 37a with slope compensation.

FIG. 40 is a circuit diagram implementing the error tracking method of FIG. 37c.

FIG. 41 is a diagram illustrating timing signals in the error tracking method of FIG. 37c.

FIG. 42 illustrates a T1 slope compensated emulated inductor current signal tracking the error voltage signal with its centroid point of rising saw-tooth edges.

FIGS. 43a-43e d illustrates five error tracking methods in accordance with embodiments of the present disclosure.

FIG. 44 is a circuit diagram implementing the error tracking method of FIG. 43a.

FIG. 45 is a diagram illustrating timing signals in the error tracking method of FIG. 43a.

FIG. 46 illustrates how the switching period is changed due to the dual-edge centroid tracking operation itself.

FIG. 47 illustrates how the skewed offset between two rising/falling centroid points causes the switching period changed.

FIG. 48 illustrates how to adjust the switching period though initial values set to the zero counter in FIG. 44.

FIG. 49 is a circuit diagram implementing the dual-edge centroid error tracking method with the switching period regulation logic in accordance with one embodiment of the present disclosure.

FIG. 50 is a circuit diagram implementing the error tracking method of FIG. 43e.

FIG. 51 is a diagram illustrating timing signals of FIG. 50.

FIG. 52 is a circuit diagram implementing the error tracking method of FIG. 43c.

FIG. 53 is a diagram illustrating timing signal of FIG. 52.

FIGS. 54a-54h are eight error tracking methods in accordance with embodiments of the present disclosure.

FIG. 55 is a circuit diagram implementing the error tracking method of FIG. 54a.

FIG. 56 is a circuit diagram implementing the error tracking method of FIG. 54e.

FIG. 57 shows output voltage waveform of a buck regulator with the dual-edge centroid error tracking method in accordance with the one embodiment of the present disclosure.

FIG. 58 shows transient simulation results of a buck regulator with the dual-edge centroid error tracking method in accordance with the one embodiment of the present disclosure.

FIG. 59 shows transient simulation results of a buck regulator with the T1 bottom error tracking method with a fixed switching period in accordance with the one embodiment of the present disclosure.

FIG. 60 shows transient simulation results of a buck regulator with the T1 centroid error tracking method with a fixed switching period in accordance with the one embodiment of the present disclosure.

FIG. 61 shows transient simulation results of a buck regulator with the T2 centroid error tracking method with regulated switching period in accordance with the one embodiment of the present disclosure.

FIG. 62 shows transient simulation result of a boost regulator with the dual-edge centroid error tracking method in accordance with the one embodiment of the present disclosure.

FIG. 63 shows transient simulation result of a buck-boost regulator with the dual-edge centroid error tracking method in accordance with the one embodiment of the present disclosure.

### DETAILED DESCRIPTION

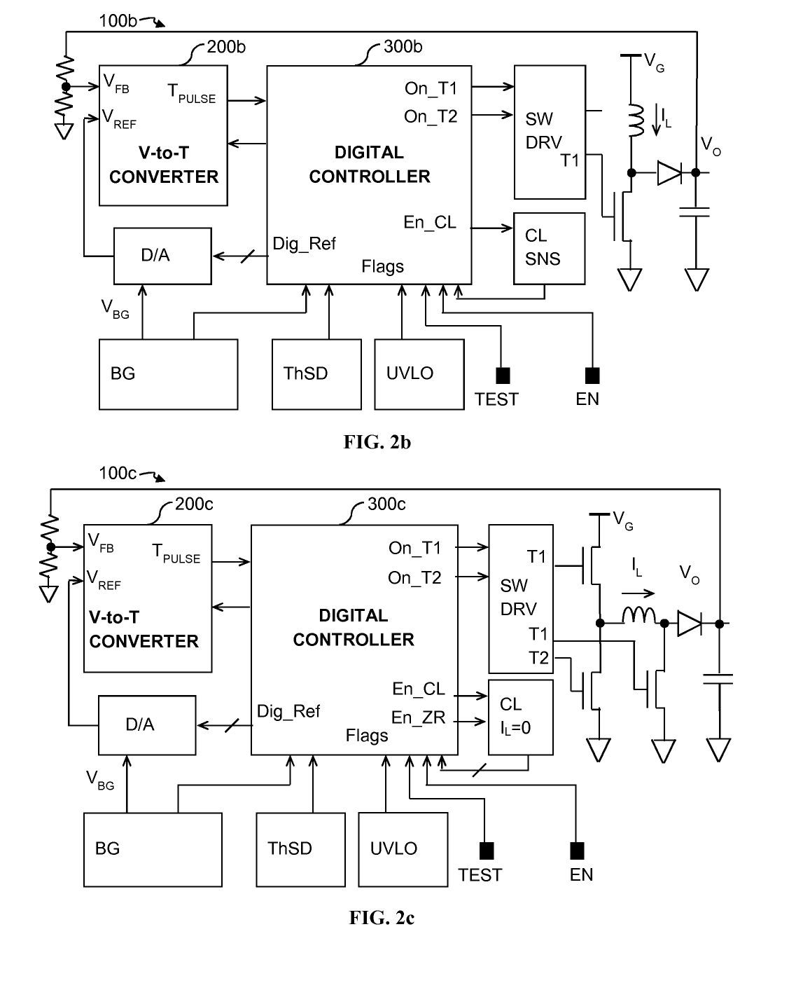

Embodiments of the present disclosure include a switching regulator designed for optimal performance and higher reliability while keeping R&D and production costs in check. FIG. 2A is a switching regulator in accordance with one embodiment of the present disclosure. The buck switching regulator 100 may include a voltage to timing pulse (V/T) converter 200, a digital controller 300, a switch drive 110, power switches 120, an inductor 130, and a capacitor 140.

The V/T converter 200 preprocess a feedback output voltage signal and converts an error voltage signal to digital timing pulse for the digital controller 300. The digital controller 300 processes the digital timing pulse and generates signals for modulation of T1 and T2 power switching intervals, and regulates the switching period (T1+T2). Details of the V/T converter 200 and digital controller 300 will be described later. The switching drive 110 is configured to drive the power switches 120 based on the power switching intervals T1 and T2 determined by the digital controller 300. By way of example, but not by way of limitation, the power switches 120 may be MOSFET transistors. These elements including the inductor 130 and capacitor 140 are well-known in the art and thus will not be described herein. It should be noted that the embodiments of the present disclosure may apply to all three types of regulators, buck regulators, boost regulators and buck-boost regulators, with minor logic changes. FIGS. 2B and 2C are circuit diagrams illustrating a boost switching regulator 100b and a buck-boost switching regulator 100c respectively in accordance with embodiments of the present disclosure.

In operation, the switch drive 110 turns the power switches 120 on and off based on the intervals T1 and T2 from the digital controller 300. When the power switches are turned on, the energy from the input voltage source is applied to the inductor 130 to allow the current through the inductor to build up. When the switches 120 are turned off, the voltage across the inductor reverses and charges are transferred onto an output capacitor 140 and the output load. The output voltage is maintained by the capacitor 140. The output voltage is feed back to the V/T converter 200 for generating an error voltage signal, and converting it to a digital timing pulse. According to the digital timing pulse, the digital controller 300 may then modulate T1 and T2 power switching intervals for voltage regulation.

Voltage to Time Converter

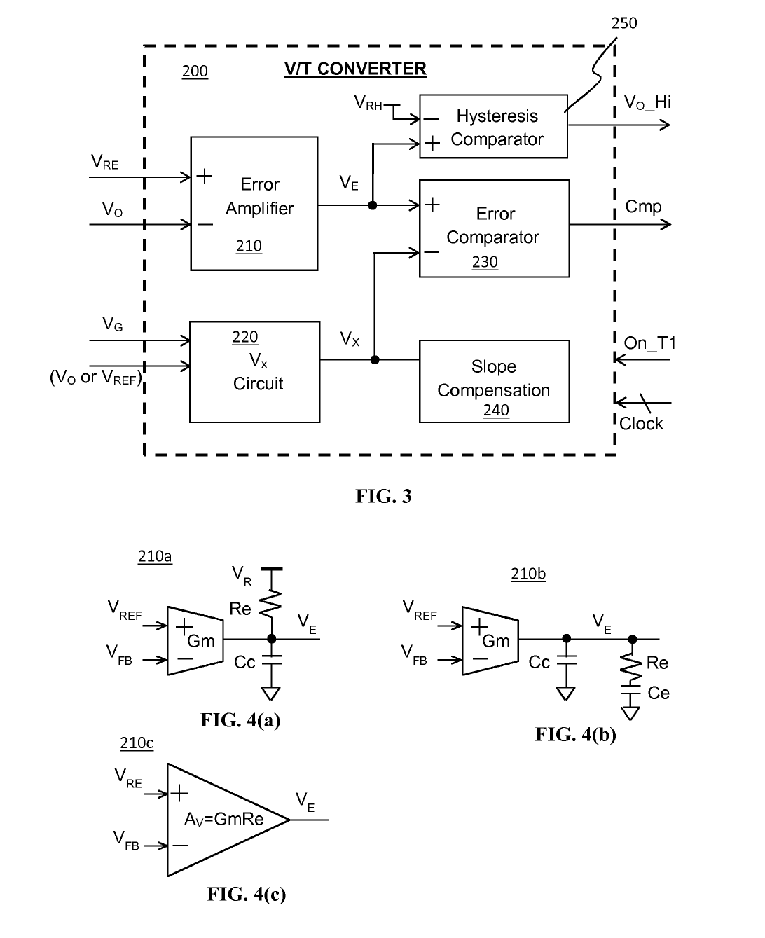

The V/T converter 200 is configured to covert an analog error voltage to a digital timing pulse. Particularly, the converter 200 generates an error voltage signal from a difference between a feedback signal and a reference signal. It also generates an emulated saw-tooth inductor current signal from an inductor current emulation circuit. The emulated inductor current signal is used as dynamic reference voltage for an error comparator to compare with the error voltage signal and generate a digital timing pulse for output to the digital controller 300. As such, the digital timing pulse carries information of relative error voltage level against the rising and falling saw-tooth edges of the reference signal. FIG. 3 is a V/T converter provided in a switching regulator in accordance with one embodiment of the present disclosure. The V/T converter 200 may include an error amplifier 210, an inductor current emulation circuit 220, an error comparator 230, an optional slope compensation circuit 240, and an optional hysteresis voltage comparator 250.

Error Amplifier

FIGS. 4a, 4b and 4c are three examples of an error amplifier that may be provided in a switching regulator in accordance with the present disclosure. The amplifier 210a is made of a differential-input trans-conductance amplifier with an output resistor and a capacitor Cc 212a to decouple high frequency noise signal. The amplifier 210b has serially-connected Re and Ce 212b at the output of a trans-conductance amplifier in order to raise the low frequency gain of the error amplifier. The amplifier 210c is a differential-input voltage amplifier.

In one embodiment of a switching regulator as shown in FIG. 5, the error amplifier 210 is a differential-input trans-conductance error amplifier which receives a feedback output voltage V0 and compares it with a reference voltage V_{REF}. The voltage difference is then amplified by GmRe and becomes an error voltage signal V_{E}. The output V_{E} of the error amplifier 210 is then sent to the error comparator 230 for comparison with an emulated inductor current signal.

Inductor Current Emulation Circuit

In order for effective control of the regulators, accurate measurement of inductor current is necessary. One conventional way of sensing inductor current is by adding a current-sensing resistor in series with the inductor. The voltage across the resistor varies with the inductor current. However, the use of a suitable current-sensing resistor adds cost to the regulators, wastes power on the sensing resistor, and introduces switching voltage and current noise into sensitive analog control circuits. Such switching noise can become a critical issue in high frequency switching regulators. The embodiments of the present disclosure include an inductor current emulation circuit for producing a voltage signal which varies with the inductor current.

As discussed in detailed below, the inductor current emulation circuit may be made of two current sources, switches and a RC network. The circuit is configured to generate a voltage signal to emulate the inductor current signal in the frequency higher than the natural frequency of the switching regulator while suppressing the signal in the low frequency spectrum. An identical circuit may be used for different type of regulators by setting switches differently.

Inductor Current

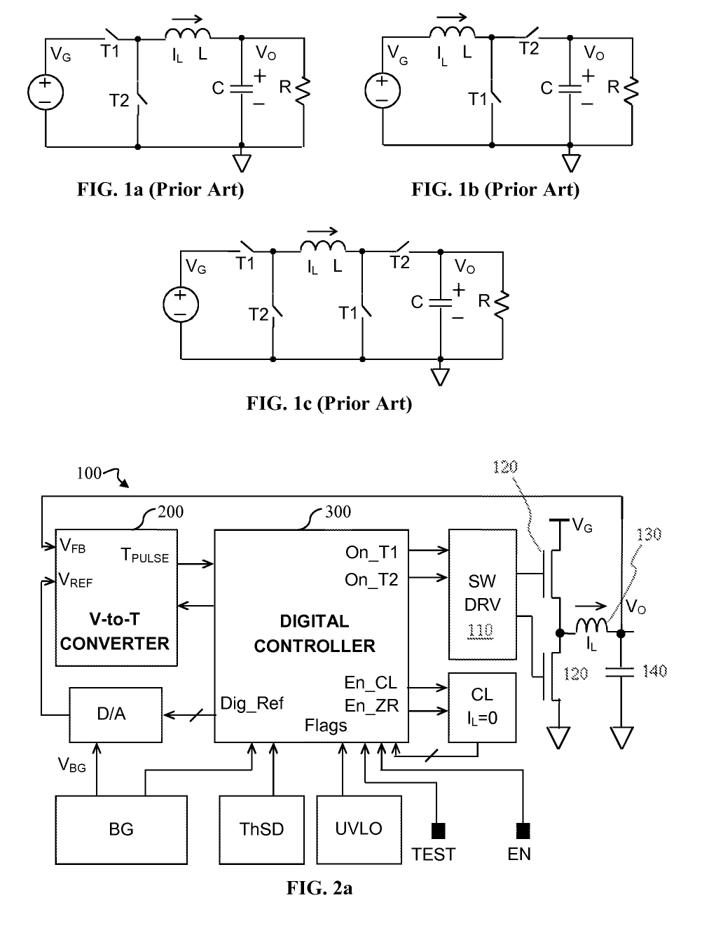

Switches in a switching regulator, such as the regulators shown in FIGS. 1a-1c, are controlled with two alternating timing signals T1 (turn-on time for the first switch) and T2 (turn-on time for the second switch). A combined time of T1 and T2 intervals defines one switching period/cycle of the regulator. In the steady state operating condition, the output voltage of a switching regulator is determined by a function of input voltage and duty cycle applied to the power switches.

In LC switching regulators, the inductor current is linearly increased during T1 interval and linearly decreased during T2 interval. Slopes of the rising and falling dynamic inductor current during T1 and T2 can be estimated from input, output voltages and inductance of the regulator inductor. Table 1 is made of inductor current slopes of three types of regulators of FIG. 2. The column of p1 in the table is for slopes during T1, and the column of p2 is for slopes during T2.

TABLE 1

| | $p 1 = \frac{d {I}_{L}}{dt} during T 1$ | $p 2 = - \frac{d {I}_{L}}{dt} during T 2$ |
|---|---|---|
| BUCK | $\frac{{V}_{G} - {V}_{O}}{L}$ | $\frac{{V}_{O}}{L}$ |
| BOOST | $\frac{{V}_{G}}{L}$ | $\frac{{V}_{O} - {V}_{G}}{L}$ |
| BUCK-BOOST | $\frac{{V}_{G}}{L}$ | $\frac{{V}_{O}}{L}$ |

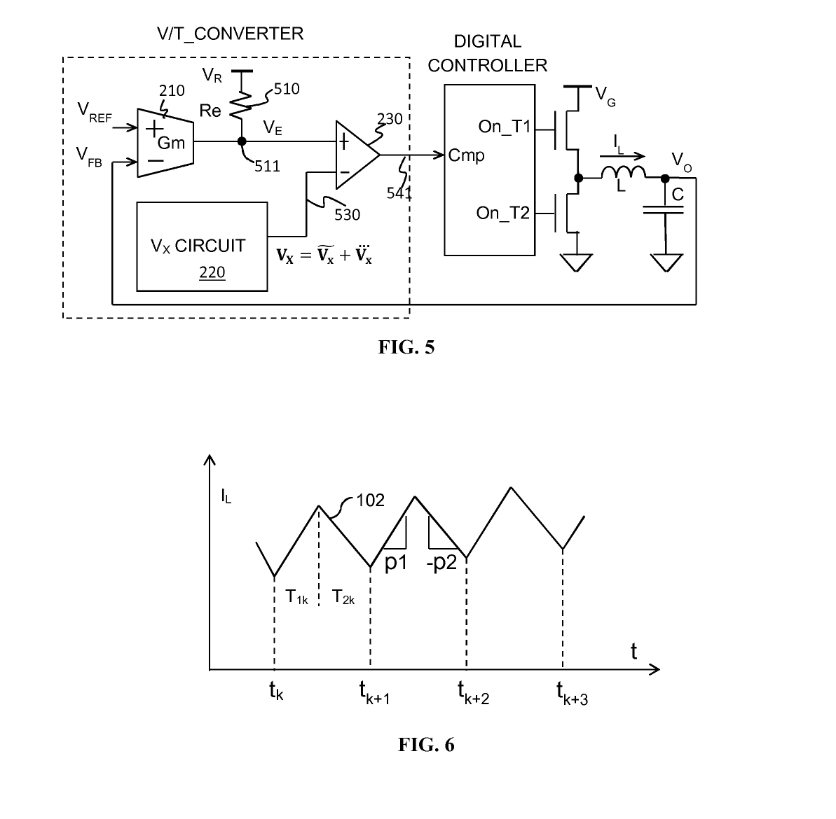

FIG. 6 shows an inductor current waveform 102 of LC switching regulators. In FIG. 6, one saw-tooth waveform of the k^{th} switching cycle is defined by rising/falling slopes in Table 1 and by three timing numbers (tₖ, T₁ₖ, T₂ₖ) where tₖ is the starting time, and T₁ₖ and T₂ₖ are switching intervals. The saw-tooth inductor current signal can be represented by:
During T1,

tₖ≦t<tₖ+T₁ₖ,

I_{L}(t)=I_{L}(tₖ)+p1·(t−tₖ);

During T2,

tₖ+T₁ₖ≦t<tₖ₊₁,

I_{L}(t)=I_{L}(tₖ)+p1·T₁ₖ−p2·(t−tₖ−T_{1k).}

Therefore, inductor current change in the k^{th} cycle is given

$$\begin{matrix}Δ {I}_{L}^{k} = {I}_{L} ( {t}_{k + 1} ) - {I}_{L} ( {t}_{k} ) \\ = p 1 \cdot {T}_{1 k} - p 2 \cdot {T}_{2 k}\end{matrix}$$

$$because$$

$${t}_{k + 1} - {t}_{k} - {T}_{1 k} = {T}_{2 k}$$

And, the inductor current at tₖ can be represented by the current slopes and a sequence of timing numbers (T₁ₖ, T₂ₖ).

$$\begin{matrix}{I}_{L} ( {t}_{k} ) = {I}_{L} ( 0 ) + {\sum }_{j = 0}^{k - 1} Δ {I}_{L}^{j} \\ = {I}_{L} ( 0 ) + {\sum }_{j = 0}^{k - 1} ( p 1 \cdot {T}_{1 j} - p 2 \cdot {T}_{2 j} ) .\end{matrix}$$

Because the output voltage is regulated to a reference voltage V_{REF}, V_{O} in Table 1 can be replaced by the reference voltage V_{REF} which is available in a controller chip.

### Emulated Inductor Current Signal

As mentioned above, the inductor current signal may be emulated by a voltage signal which may be internally produced with an inductor current emulation circuit. First, each current slope parameter (p1 or p2) in Table 1 is multiplied by L/Rx and mapped to a current parameter in Table 2.

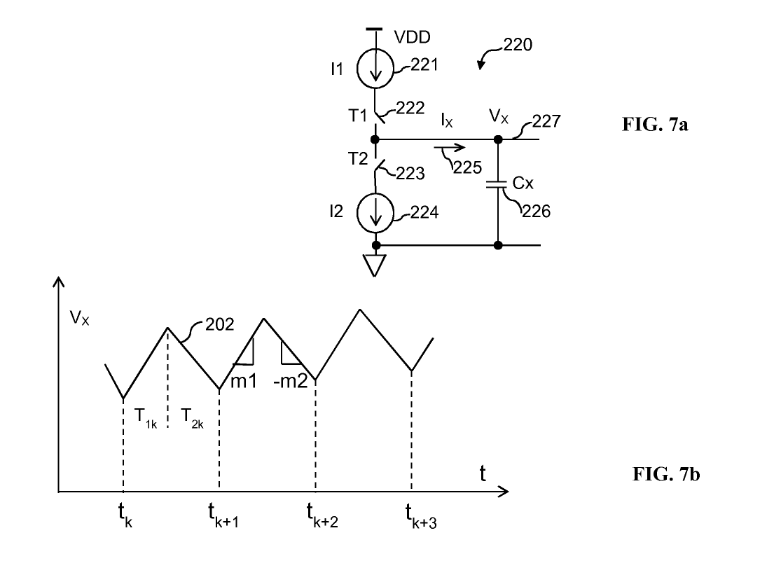

In an example inductor current emulation circuit 220 of FIG. 7a, the current parameters I1 and I2 in Table 2 are realized with two current sources 221, 224, and a capacitor Cx 226 is charged with the current I1 during T1 and discharged with I2 during T2 through switches 222, 223. Because the capacitor voltage signal V_{X}(t) 227 is intended to mimic the inductor current signal I_{L}(t) in FIG. 6, the I1 and I2 currents are switched with the same sequence of timings (tₖ, T₁ₖ, T₂ₖ) of the switching regulator.

TABLE 2

| | $I 1 = p 1 \cdot \frac{L}{Rx} during T 1$ | $I 2 = p 2 \cdot \frac{L}{Rx} during T 2$ |
|---|---|---|
| BUCK | $\frac{{V}_{G} - {V}_{O}}{Rx}$ | $\frac{{V}_{O}}{Rx}$ |
| BOOST | $\frac{{V}_{G}}{Rx}$ | $\frac{{V}_{O} - {V}_{G}}{Rx}$ |
| BUCK-BOOST | $\frac{{V}_{G}}{Rx}$ | $\frac{{V}_{O}}{Rx}$ |

Rx is a design parameter.

The following equations show that the capacitor voltage signal V_{X}(t) emulates the inductor current signal in every aspect.

First, capacitor voltage V_{X}(t) in the k^{th} cycle is given,

$$During T 1 , {V}_{x} ( t ) = {V}_{x} ( {t}_{k} ) + \frac{I 1}{Cx} \cdot ( t - {t}_{k} ) ;$$

$$During T 2 , {V}_{x} ( t ) = {V}_{x} ( {t}_{k} ) + \frac{I 1}{Cx} \cdot {T}_{1 k} - \frac{I 2}{Cx} \cdot ( t - {t}_{k} - {T}_{1 k} ) .$$

Therefore, voltage signal V_{X}(t) change in the k^{th} cycle is given by

$$\begin{matrix}Δ {V}_{x}^{k} = {V}_{x} ( {t}_{k + 1} ) - {V}_{x} ( {t}_{k} ) \\ = \frac{I 1}{Cx} \cdot {T}_{1 k} - \frac{I 2}{C x} \cdot {T}_{2 k} .\end{matrix}$$

And the capacitor voltage at tₖ can be represented by

$$\begin{matrix}{V}_{x} ( {t}_{k} ) = {V}_{x} ( 0 ) + {\sum }_{j = 0}^{k - 1} Δ {V}_{x}^{j} \\ = {V}_{x} ( 0 ) + {\sum }_{j = 0}^{k - 1} ( \frac{I 1}{Cx} \cdot {T}_{1 k} - \frac{I 2}{C x} \cdot {T}_{2 k} ) .\end{matrix}$$

Table 3 is made of slopes of V_{X}(t), in which m1 is slope during T1 and m2 is during T2. Between the current slopes of Table 1 and the voltage slopes of Table 3, a linear relationship exists.

During T1,

$$m 1 = \frac{L}{RxCx} \cdot p 1 ,$$

During T2,

$$m 2 = \frac{L}{RxCx} \cdot p 2.$$

Because I_{L}(t) and V_{X}(t) have the same sequence of switching timings defined by (tₖ, T₁ₖ, T₂ₖ),

$${V}_{x} ( t ) = \frac{L}{RxCx} \cdot {I}_{L} ( t )$$

if V_{X}(0)=0 and I_{L}(0)=0

That is, V_{X}(t) is linearly proportional to I_{L}(t) all the times. As shown in FIG. 7b, the voltage signal V_{X}(t) emulates the inductor current signal I_{L}(t) by mimicking its dynamic waveform.

TABLE 3

| | $m 1 = \frac{d {V}_{X}}{dt} during T 1$ | $m 2 = - \frac{d {V}_{X}}{dt} during T 2$ |
|---|---|---|
| BUCK | $\frac{{V}_{G} - {V}_{O}}{RxCx}$ | $\frac{{V}_{O}}{RxCx}$ |
| BOOST | $\frac{{V}_{G}}{RxCx}$ | $\frac{{V}_{O} - {V}_{G}}{RxCx}$ |
| BUCK-BOOST | $\frac{{V}_{G}}{RxCx}$ | $\frac{{V}_{O}}{RxCx}$ |

Rx and Cx are design parameters.

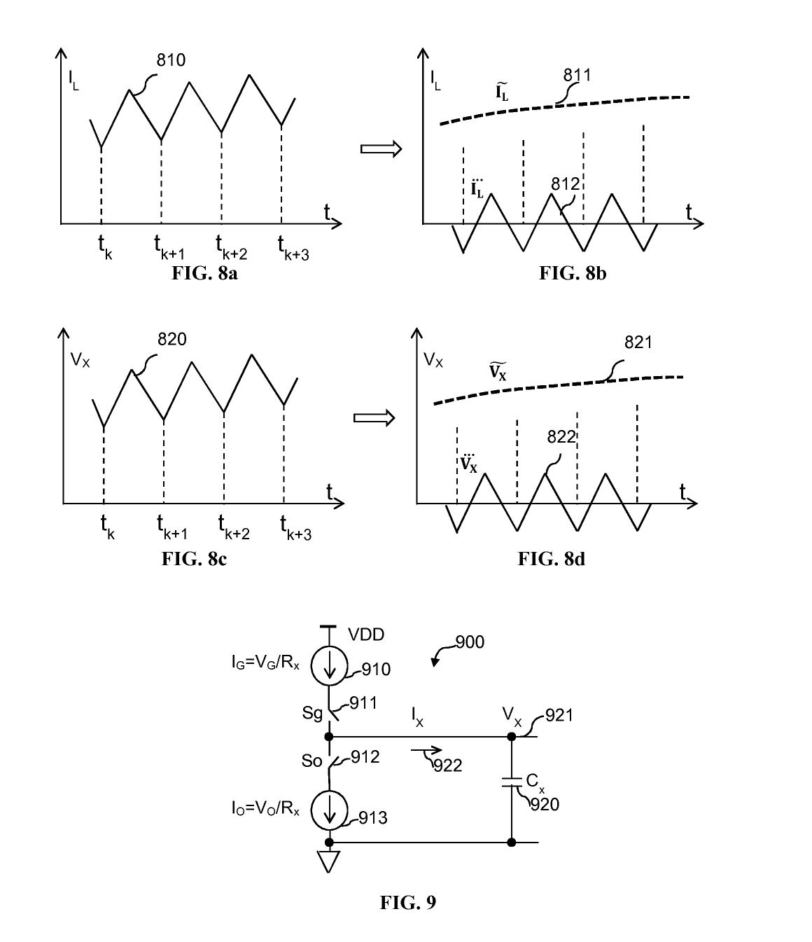

In FIG. 8c, an emulated inductor current signal V_{X}(t) 820 is represented with two types of signals. One is an averaged, low frequency signal 821 and the other is a saw-tooth signal 822 representing rising and falling inductor current edges. That is,

V_{X}(t)= [symbol] (t)+ [symbol] (t)
where [symbol] (t) 821 is an averaged term and [symbol] (t) 822 is a saw-tooth term, as shown in FIG. 8d.

The inductor current signal I_{L}(t) 810 in FIG. 8a is also represented with two terms.

I_{L}(t)= [symbol] (t)+ [symbol] (t)
where [symbol] (t) 811 is an averaged term and [symbol] (t) 812 is a saw-tooth term, as shown in FIG. 8b.

And it is obvious that the linear equation

$${V}_{x} ( t ) = \frac{L}{RxCx} {I}_{L} ( t )$$

is true for the averaged terms and for the saw-tooth terms respectively.

$$( t ) = \frac{L}{RxCx} ( t ) = \frac{L}{RxCx} ( t )$$

FIG. 9 illustrates an example inductor current emulation circuit configured to generate I1 and I2 in Table 2. First the circuit generates two currents I_{G}=V_{G}/Rx 910 and I_{O}=V_{O}/Rx 913 where V_{G} is input and V_{O} is output voltage. Then two current switches 911, 912 are controlled such that sum of two currents, I_{X} 922, is equal to I1 during T1 and I2 during T2 respectively. Table 4 shows how to set switches 911, 912 during T1 and T2 for three types of regulators.

TABLE 4

| | (S_{G}, S_{O}) during T1 | (S_{G}, S_{O}) during T1 |
|---|---|---|
| BUCK | (S_{G} = 1, S_{O} = 1) | (S_{G} = 0, S_{O} = 1) |
| BOOST | (S_{G} = 1, S_{O} = 0) | (S_{G} = 1, S_{O} = 1) |
| BUCK-BOOST | (S_{G} = 1, S_{O} = 0) | (S_{G} = 0, S_{O} = 1) |

S_{G} and S_{O} are current switches. 1 = ON and 0 = OFF.

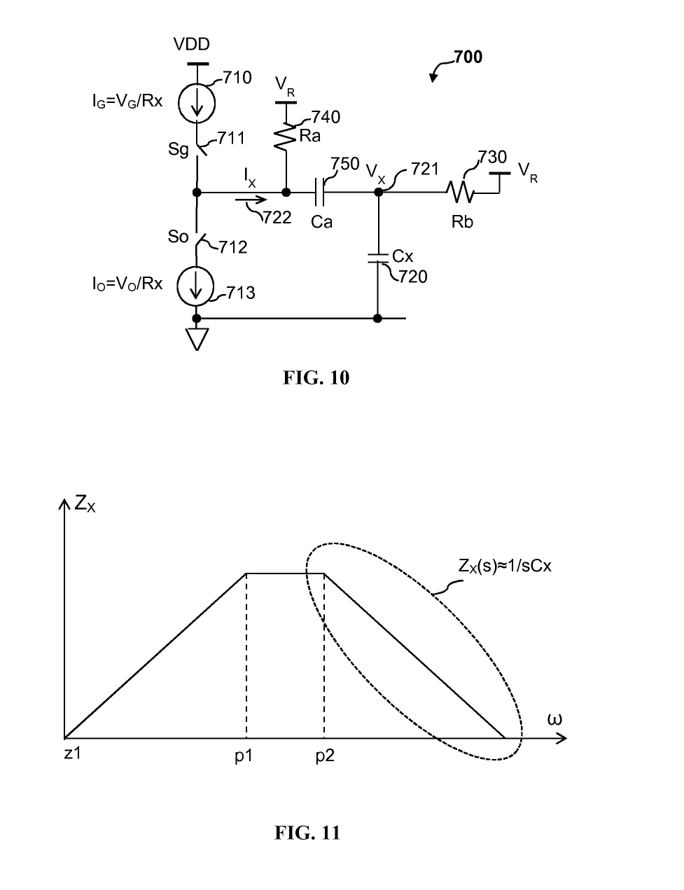

FIG. 10 is an inductor current emulation circuit 700 that are similar to the circuit of FIG. 9 with three additional components (Ra, Ca, and Rb). The transfer impedance function of the RC network of Cx 720, Ca 750, Ra 740 and Rb 730 is given by:

$$\frac{\tilde{{I}_{X}} ( s )}{} = \frac{sCaRaRb}{1 + s ( CaRa + CaRb + CxRb ) + {s}^{2} CaCxRaRb} ≅ \frac{sCaRaRb}{( 1 + sCa ( Ra + Rb ) ) ( 1 + sCx \frac{RaRb}{RaRb} )}$$

$$where Ca ≫ Cx .$$

FIG. 11 shows a Bode plot of the transfer impedance function which has two poles,

$$p 1 \approx \frac{1}{2 π Ca ( Ra + Rb )} and p 2 \approx \frac{1}{2 π Cx \frac{RaRb}{Ra + Rb}} .$$

In the frequency higher than the second pole p2, the transfer function is approximated by an integrator

$$\frac{1}{sCx} .$$

The RC network is approximated by a capacitor Cx. In the frequency lower than the first pole p1, the RC network is a high-pass filter which is blocking the switching current signal I_{X} in the low frequency spectrum.

In the design of the circuit 700 in FIG. 10, the second pole p2 has to be placed at a frequency lower than the natural frequency of a switching regulator in order for the V_{X} signal to mimic the inductor current signal close enough in the frequency range where the stability of a switching regulator is determined. On the other hand, the first pole p1 has to be at the highest frequency possible in order to suppress V_{X} in the low frequency spectrum. The low frequency spectrum V_{X} signal can makes the V_{X} signal swing wider voltage range resulting in less voltage headroom for the inductor signal emulation circuit and other circuits that the V_{X} signal is connected to, and the low frequency term can cause output voltage error if the error amplifier gain is not high.

Additionally, Ra 740 and Rb 730 in the circuit 700 have additional functions. Rb is tying V_{X} to a reference voltage setting its DC value, and Ra is tying the high impedance current node to a reference voltage.

In the small signal, low frequency AC analysis, output impedance of a buck regulator is 1/(sC+1/R) where C is output capacitance and R is load resistance. Therefore, small-signal averaged AC regulator output voltage is represented by

[symbol]

(s)= [symbol] (s)·1/(sC+1/R)

[symbol]

(s)≈ [symbol] (s)·1/sC
where sC>>1/R.
   For boost and buck-boost regulators, the equation has to consider that the inductor current charges the capacitor during T2 only. Therefore,

[symbol]

(s)≈ [symbol] (s)·1/sC·(1−D)
where D=T1/(T1+T2)

On the other hand, V_{X}(t) is emulating I_{L}(t) with a linear relation

$${V}_{x} ( t ) = \frac{L}{RxCx} {I}_{L} ( t ) .$$

Therefore, the small signal, averaged AC [symbol] (s) can be represented by [symbol] (s):

[symbol]

(s)≈(sCL/RxCx)· [symbol] (s)
in buck,

$$( s ) ≅ ( sCL / RxCx ) \cdot ( s ) \cdot \frac{1}{1 - D}$$

in boost and buck-boost.

The small signal, averaged [symbol] (t) is approximated by the first-order derivative of [symbol] (t). According to the present disclosure, the emulated current signal acts like the first-order derivative of output signal in the second-order control system. As discussed later, the first-order derivative term (i.e., the emulated current signal) creates a phase compensation zero in the feedback control loop, which improve the stability of the switching regulator.

Error Voltage Comparator

An error voltage comparator receives the emulated inductor current signal V_{X} from the inductor current emulation circuit and error voltage signal V_{E} and generate a timing pulse Cmp after comparison between the two signals.

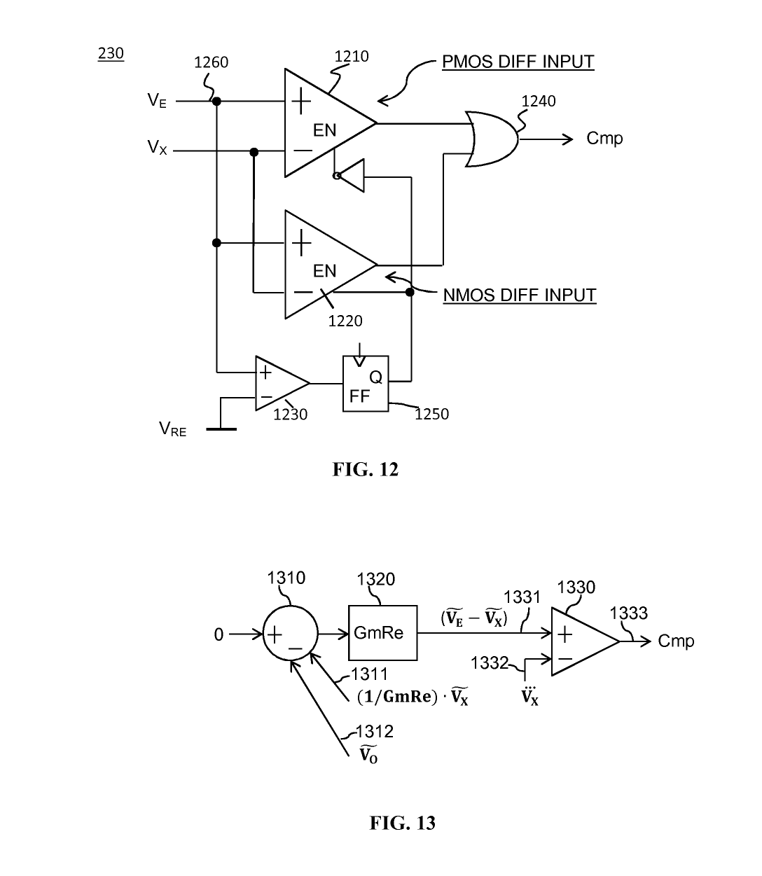

FIG. 12 is an example error comparator configured to extend its input voltage range from zero to supply voltage level. Specifically, two different types of comparators (a PMOS differential-input comparator 1210 and a NMOS differential-input comparator 1220) are tied together to do the error comparison. The comparator with NMOS inputs is supposed to operate in the high V_{E} range and the comparator with PMOS inputs is supposed to operate in the low V_{E} range. Then, the third comparator 1230 defines two voltage ranges of V_{E}, “high” and “low”, and the comparator output signal selects and enables one error comparator which is designed for the V_{E} voltage range at the time. Alternating of two error comparators is synchronized to a clock signal coming from the digital controller.

In FIG. 13, for the sake of small signal AC analysis, the error amplifier is modeled by an ideal voltage signal subtractor 1310 and a GmRe voltage gain block 1320. Then, the [symbol] term of V_{X} 530 of FIG. 5 is moved from a negative input of the error comparator 230 to an extra negative input of the subtractor 1310. The [symbol] term maintains same sign. However it is scaled by 1/GmRe. And the error comparator 1330 compares ( [symbol] − [symbol] ) to [symbol] in the small signal AC equivalent circuit.

At the inputs of the error amplifier, [symbol] (s) and [symbol] (s) can be combined together as below.

$$( s ) + \frac{1}{GmRe} \cdot ( s ) ≅ ( 1 + s \cdot \frac{1}{GmRe} \cdot \frac{LC}{RxCx} ) \cdot ( s )$$

for buck,

$$( s ) + \frac{1}{GmRe} \cdot ( s ) ≅ ( 1 + s \cdot \frac{1}{GmRe} \cdot \frac{LC}{RxCx} \cdot \frac{1}{1 - D} ) \cdot ( s )$$

for boost and buck-boost.

Therefore, in the small-signal AC circuit in FIG. 13, the feedback transfer function becomes

$${h}_{f} ( s ) ≅ ( 1 + s \cdot \frac{1}{GmRe} \cdot \frac{LC}{RxCx} )$$

for buck

$${h}_{f} ( s ) ≅ ( 1 + s \cdot \frac{1}{GmRe} \cdot \frac{LC}{RxCx} \cdot \frac{1}{1 - D} )$$

for boost and buck-boost.

That is, a phase-compensation zero z_{f} is placed in the feed-back path at a frequency

$${z}_{f} ≅ \frac{GmReRxCx}{LC}$$

for buck,

$${z}_{f} ≅ \frac{GmReRxCx}{LC} \cdot ( 1 - D )$$

for boost and buck-boost.

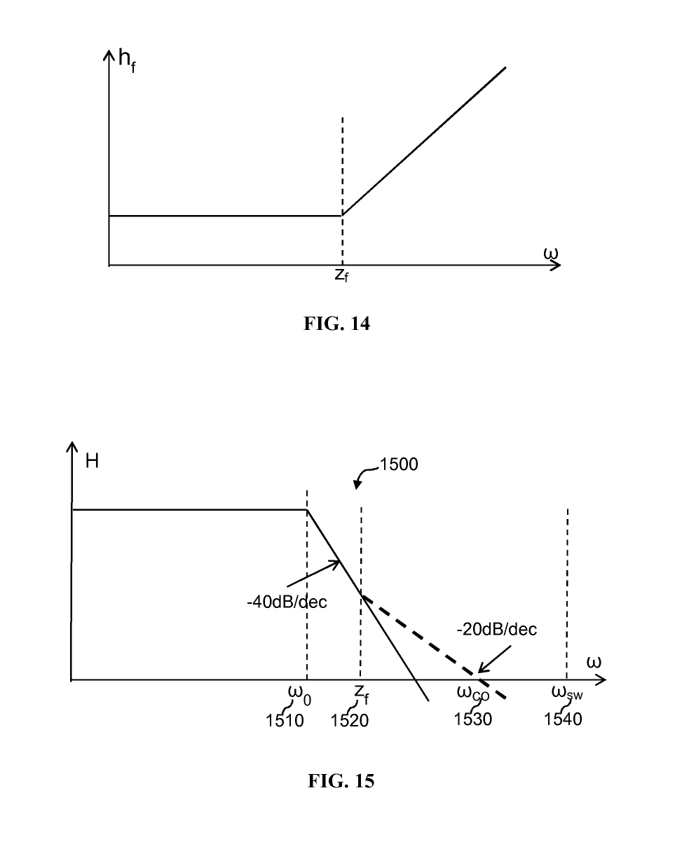

FIG. 14 shows a Bode plot of the transfer function. Note that the phase compensation zero z_{f} is created in the feed-back loop by the emulated inductor current signal. Simulations shows that the phase compensation zero help to improve stability of the switching regulators.

FIG. 15 is a Bode plot of the open loop transfer function of a buck switching regulator. As shown, a phase-compensation zero 1520 is placed between the natural frequency 1510

$${ω}_{0} = \frac{1}{\sqrt{LC}}$$

and the cutoff frequency 1530 ω_{co}. The phase compensation zero 1520 makes the transfer function curve cross its cutoff point with −20 dB/decade slope and provides phase margin for stability of the switching regulator. Farther the zero is located from the cutoff, more phase margin is given for stability. However, the cutoff frequency cannot be pushed too close to the switching frequency 1240 ω_{sw}. If GmReRxCx>\sqrt{LC} in a buck converter, then the zero is at a frequency higher than ω₀. Once GmReRxCx is determined by the internal circuit parameters, L and C are only parameters that may be adjusted to move the location of the phase compensation zero.

In the boost and buck-boost regulators, the natural frequency is approximated by

$${ω}_{0} ≅ \frac{1}{\sqrt{LC}} \cdot ( 1 - D ) .$$

The phase compensation zero is also scaled by (1-D), that is

$${z}_{f} ≅ \frac{GmReRxCx}{LC} \cdot ( 1 - D ) .$$

Therefore the same V/T converter can be used for the phase compensation for three different types of regulators without changing design parameters.

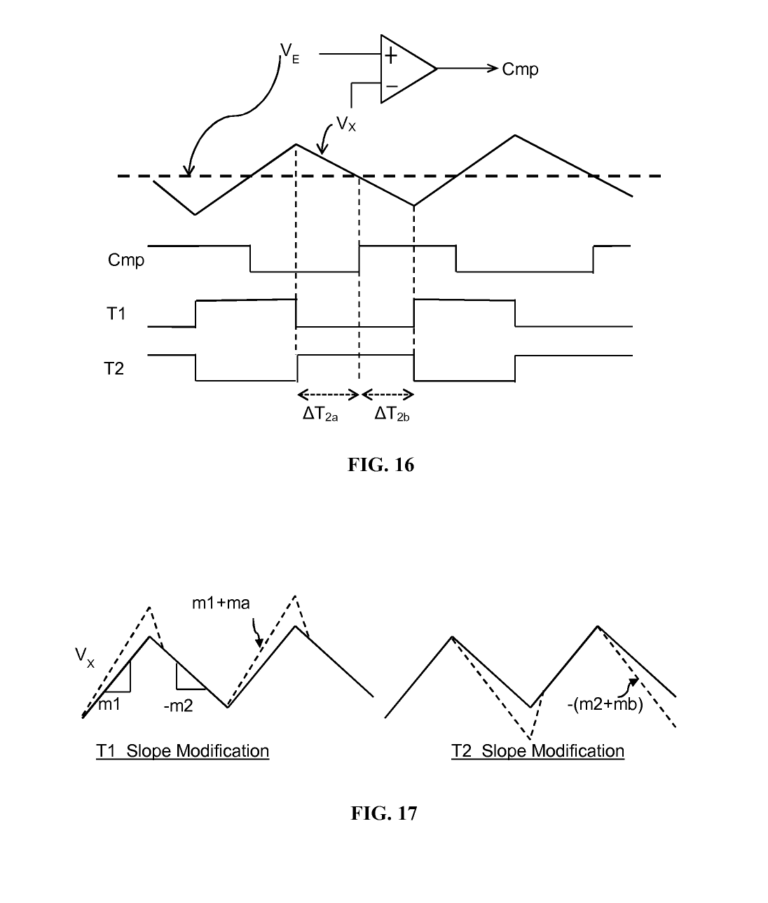

In FIG. 16, the error voltage V_{E} is compared to the dynamic saw-tooth reference V_{X} by an error comparator, and the digital timing pulse “Cmp” is generated for a digital controller provided in the switching regulator. When the digital controller measures timing delays between Cmp and T1/T2 pulses, the controller is able to estimate relative error voltage level by comparing the crossing points of two signals and the rising/falling saw-tooth edges of V_{X}. As an example shown in FIG. 16, two time delays ΔT2a and ΔT2b are measured from Cmp and T2 pulses. The controller may calculate the relative error voltage level by ΔT2/(ΔT2a+ΔT2b). If the digital controller makes the relative error voltage level ΔT2b/(ΔT2a+ΔT2b)=0.5 by ending T2 when ΔT2b is equal to ΔT2a, then the modulation process for T2 will force the error voltage signal V_{E} to cross the saw-tooth reference signal V_{X} at the center of falling edges. The method for the digital controller to modulate T2 for V_{E} to cross V_{X} at the center of falling V_{X} edges is called “T2 centroid error tracking”. The same modulation may be done on T1 by the controller and that is called “T1 centroid error tracking”. If the modulation is done on both T1 and T2 intervals, that is called by “dual-edge centroid error tracking.” These methods will be discussed later in this specification.

Slope Compensation Circuit

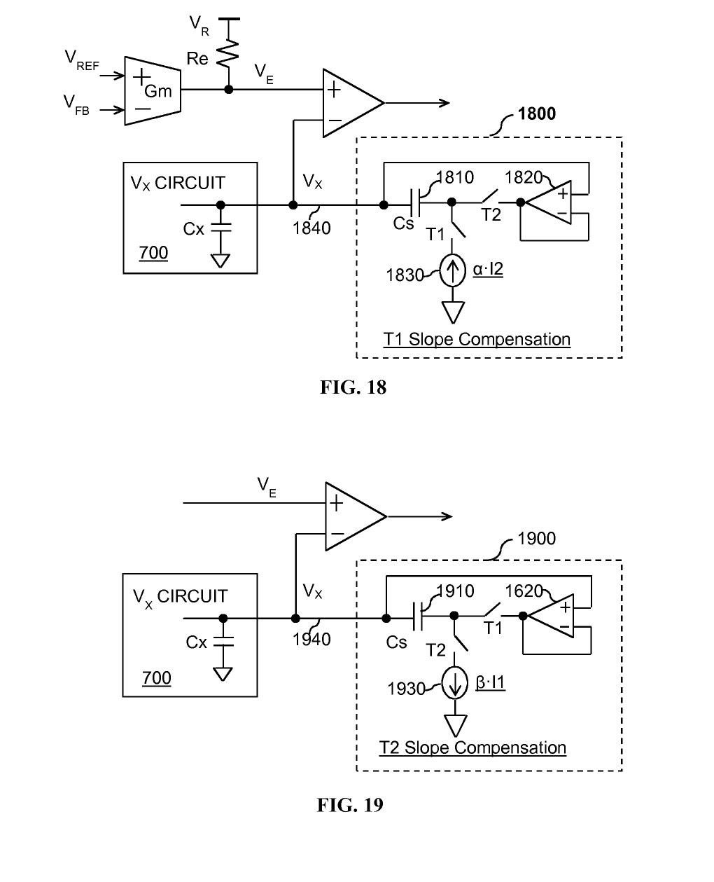

A V/T converter in accordance with the present disclosure may include a slope compensation circuit to manipulate slope of one saw-tooth edge of the emulated inductor current signal V_{X} in order to make the regulator system stable. FIG. 17 shows that one edge slope of V_{X} is raised by fixed amount during one switching interval, and then the voltage change on V_{X} due to the added slope is removed in the following interval. FIGS. 18 and 19 show two examples in which one edge slope is raised by adding some portion of the other edge slope through a slope compensation circuit. Alternatively, the slope compensation can be done by adding some portion of its own slope with a slope compensation circuit. Selection of a specific slope compensation method depends on the error tracking method of a switching regulator.

FIG. 18 shows an example of a V/T converter which includes a slope compensation circuit 1800 for T1 slope. Changing the slope of V_{X} during T1 can be done by adding additional current through a capacitor Cs 1810 by turning on the S1 switch while turning the S2 switch off in the slope compensation circuit 1800. The slope-compensation current 1830 can be made from current I2.

A virtue of this slope compensation method is that all charges added in T1 can be removed from Cx in the following interval T2. The current that is added to Cx through the capacitor Cs is also accumulated in Cs at the end of a slope-changing interval T1. In the following interval T2 with S2 switch turning on, the accumulated charge in Cs is discharged by connecting the output of a unite-gain operational amplifier 1820 to a Cs node. As a result, all the charges added to Cx for the slope compensation in the previous interval T1 are removed.

FIG. 19 shows an example of a VT converter with a slope compensation circuit 1900 for T2 slope. The slop compensation current is added to capacitor Cx during T2 and the charges are removed in the following T1.

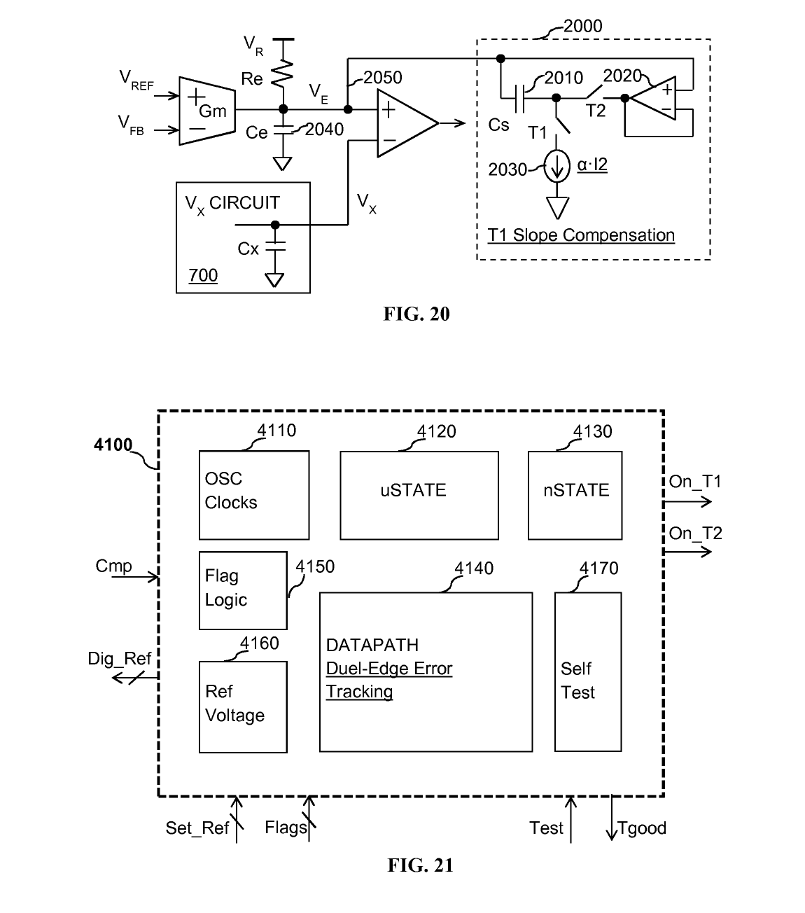

FIG. 20 is another example of a VT converter with a slope compensation circuit 2000. The slope compensation is done by adding slope on the error voltage V_{E} signal 2050 instead of V_{X} signal. This makes same effect on stability of the switching regulators. If the same amount, opposite direction current is added to the V_{E} node and the V_{E} node has a capacitor Ce 2040, then the effective slope change is Cx/Ce times of the V_{X} slope change.

Hysteresis Voltage Comparator

A V/T converter in accordance with the present disclosure may have a hysteresis comparator. A hysteresis comparator is configured to detect the high/low output voltage conditions. If high output voltage is detected, hysteresis voltage comparator puts the regulator to sleep. If low output voltage is detected, the hysteresis voltage comparator wakes up the regulator.

Digital Controller

According to embodiments of the present disclosure, a LC switching regulator may include a micro-programmed, self-testable digital controller. The digital controller may be configured to modulate both power switching intervals (T1 and T2) in a switching cycle for error tracking and output voltage regulation. The controller is programmed by two state machines. A small four-state machine defines dynamic on/off states of power switches, and it controls a stoppable clock oscillator. A micro-programmed synchronous state machine monitors flag signals from various sensors and directs a switching regulator through a sequence of operational modes from turning-on to turning-off. In addition, the controller can ramp digital reference voltage up and down to different voltage levels while doing output voltage regulation, and it is fully self-testable. It should be noted that the digital controller in accordance with the present disclosure may be used for typical buck, boost, and buck-boost regulators with minor logic changes.

As shown in FIG. 21, an example of a digital controller may be a special-function microprocessor 4100 that includes an oscillator and clock generator 4110, a small four-state state machine 4130, a synchronous state machine 4120, a datapath 4140, a flag logic block 4150, a reference voltage block 4160, and a test block 4170.

Oscillator and Clock Generator

The digital controller 4100 may include an oscillator and clock generator which provides stoppable clock signals. Once the clocks are stopped, the controller is on sleep and consumes no power.

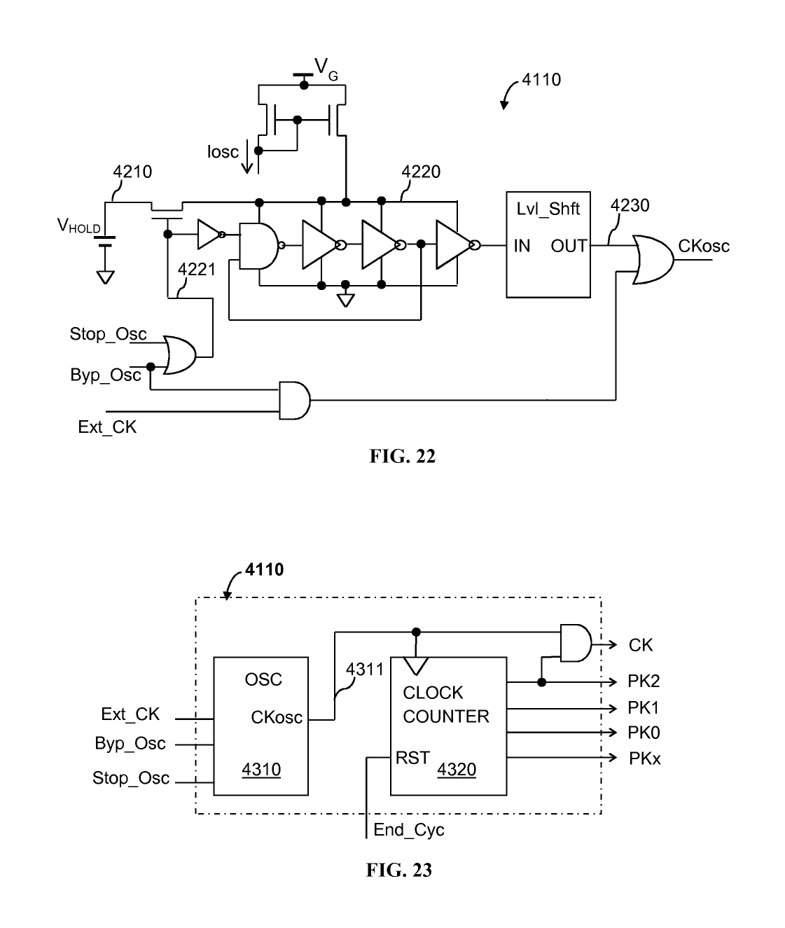

The oscillator 4110 in FIG. 22 is an example ring oscillator powered by a current source. Its oscillation can be stopped and resumed with a stop signal 4221. When it is stopped, the ring oscillator sets its output low and it consumes no power. While stopped, its ring oscillator supply voltage 4220 is held at the same level of oscillation by a voltage source 4210. As such, the ring oscillator 4110 can resume its oscillation as soon as the stop signal 4221 becomes inactive.

In addition, the ring oscillator 4110 can be turned off by a bypass signal, and an external clock signal can be selected as the output clock signal “CKosc”. This bypass function is useful for debugging and testing chips. This bypass function is necessary when the controller 4100 has to be synchronized to an external clock.

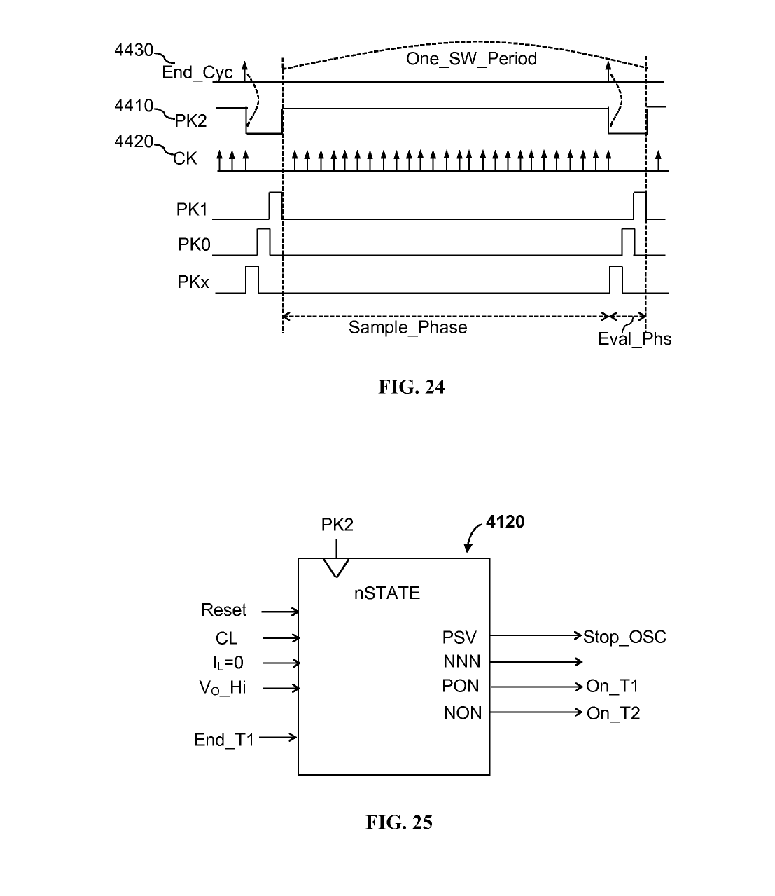

FIG. 23 shows an oscillator 4310 and a binary clock counter 4320 counting the oscillator clock 4311. FIG. 24 shows clock signals generated by the oscillator 4310 and the clock counter 4320. Specifically, the PK2 clock signal 4410 defines one switching period from a rising edge to the next rising edge. The PK2 clock signal 4410 divides one switching period into two phases, a sampling phase when the PK2 signal is high and an evaluation phase when the PK2 signal is low. Each clock cycle of the PK2 signal has to be triggered by a reset pulse End_Cyc 4430 from the datapath 4140. The reset pulse End_Cyc 4430 resets the clock counter 4320, and the counter logic keeps the PK2 signal low for six oscillator clock cycles before setting it to high. Therefore, the evaluation phase of a switching cycle is fixed to six oscillator clock cycles and the time is allocated at the end of a switching cycle. The sampling phase of each switching cycle is from the beginning of a switching cycle to the reset pulse from the datapath.

During the sampling phase, the digital controller samples the digital timing pulse Cmp from the V/T converter and counts timing data. The sampling and counting operations are synchronized to the sampling clock signal CK 4420 generated by logically ANDing the oscillator clock CKosc with the PK2 clock. During the evaluation phase, the controller checks flag signals and determines the next states of two state machines 4120, 4130. Initial values of the error-tracking zero counter for the switching period regulation is also calculated during the evaluation phase. During this phase, three additional evaluation clocks (“PKx”, “PK0” and “PK1”) are produced to conduct sequential pipelined computations in the datapath 4140, to synchronize state transitions of uSTATE and nSTATE machines, and to interface flag signals to other blocks.

Four-State State Machine

The digital controller includes a four-state state machine configured to determine dynamic on/off states of power switches and put the controller on sleep. Specifically, the four-state state machine nSTATE that may be made of a few set/reset latches and basic logic gates defines dynamic states of power switches and/or irregular operations, such as skipping switching cycles or entering to the sleep mode waiting for a wake-up signal. The nSTATE machine 4120 has four states defining dynamic on/off states of the power switches and controlling the clock oscillator.

FIG. 25 shows the nSTATE machine with input and output signals. It is synchronized to the PK2 clock signal while allowing asynchronous state transitions triggered by certain input signals (e.g., Reset, CL, I_{L}=0, and End_T1). The machine has four states (PSV, PON, NON and NNN). When it is in reset, the machine is in PSV state where all the power switches are turned off and the clock oscillator is stopped. In PON state, it turns T1 power switches on and T2 switches off. In NON state, it turns the T2 power switches on and T1 switches off. In NNN state, all the power switches are turned off without stopping the oscillator.

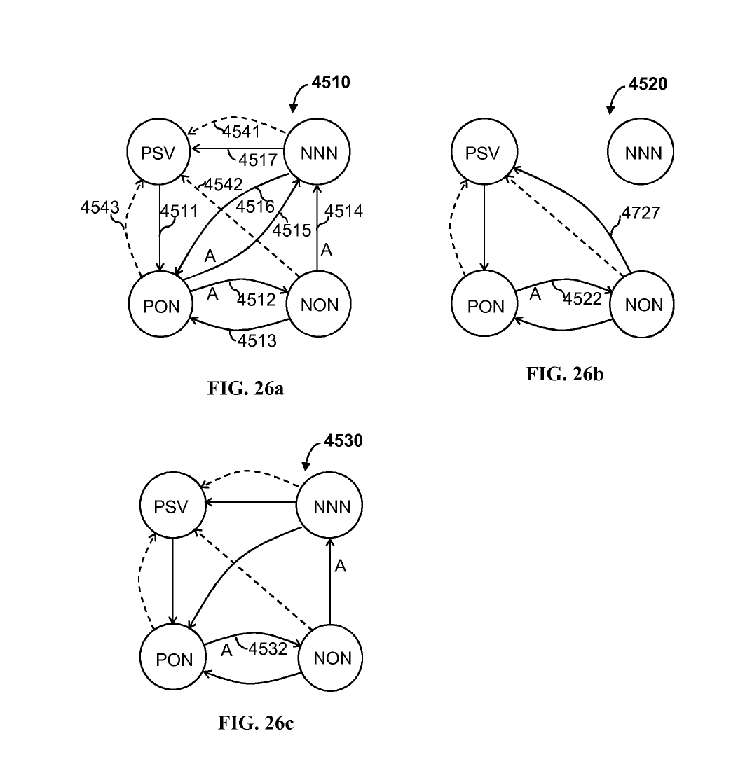

FIGS. 26a-26c show three state transition diagrams designed for buck, boost and buck-boost regulators. In the state transition diagram 4510 for a buck regulator in FIG. 26a, the nSTATE machine is in PSV state when it is reset. It moves to PON state (transition 4511) when the PK2 clock signal becomes high and if Reset=0 and V_{O—}Hi=0. In PON state, T1 power switches are turned on. A asynchronous transition 4512 from PON state to NON state is triggered by the End_T1 signal from the datapath. In NON state, T2 power switches are turned on. When the PK2 signal goes high again to start a new cycle, it jumps to PON state (transition 4513). The state machine continues these alternating PON and NON transitions 4512, 4513 for the output voltage regulation. The normal PON and NON alternating transitions may be interrupted by either signal CL or I_{L}=0. An active CL flag can trigger the asynchronous transition 4515 from PON state to NNN state in which all the power switches are turned off. An active signal I_{L}=0 can trigger the asynchronous transition 4514 from NON state to NNN state (if the discontinuous conduction mode is enabled for the regulator). If the nSTATE machine is in NNN due to an active I_{L}=0 and the “output voltage high” flag is true, then the machine jumps to PSV (transition 4517) at the next PK2 cycle to enter sleep mode by stopping the oscillator clock. Otherwise, the machine jumps to PON state (transition 4516). In addition to those three asynchronous transitions and four synchronous transitions, the reset signal can force the machine to jump back to PSV state (transitions 4541, 4542 and 4543) any time.

A boost regulator senses CL during T1 (as shown in FIG. 2B). For a boost regulator, the state transition diagram 4520 in FIG. 26b is designed based the transition diagram 4510 designed for buck regulators, and there are a few changes made to reflect differences from the buck. First, the NNN state is not used in the machine, because there is no transition to NNN state. There is no transition from NON state to NNN state during T2 because there is no zero-current sensing. Also there is no transition from PON state to NNN state during T1 because the CL flag is logically ORed with the End_T1 signal to trigger the transition 4522 from PON state to NON state. In this design, the high output voltage flag “V_{O—}Hi” triggers the synchronous transition 4727 from NON state to PSV state to put the regulator on sleep.

A buck-boost switching regulator senses CL during T1 and “zero inductor current” during T2 (as shown in FIG. 2C). Its state transition diagram 4530, shown in FIG. 26c, is similar to the buck state transition diagram 4510 except one transition. In this buck-boost design, the CL flag is logically ORed with the End_T1 signal. Therefore, an active CL or End_T1 signal can trigger the transition 4532 from PON to NON. Because of that, there is no transition from PON state to NNN state. As seen in the design of two state transition diagrams 4520, 4530 for the boost and buck-boost regulators, the nSTATE machine is easily modified for different types of switching regulators and for different applications.

Synchronous State Machine

The synchronous state machine may be configured to direct the switching regulators through different operational modes, such as turning-on and turning-off as the response to active flag signals from various sensors.

An LC switching regulator goes through a sequence of different operational modes from turning-on to turning-off. And the regulator responds differently for various active flag signals creating extra operational modes implicitly. Designers used to use various analog and digital ad-hoc schemes to implement those modes in the switching regulators. In this digital controller, a micro-programmed synchronous state machine is designed as a generic, universal solution for the problem. Each state in the state machine represents an operational mode of the switching regulator and its micro instruction word programmed in ROM generates control signals to set specific operational functions for the state.

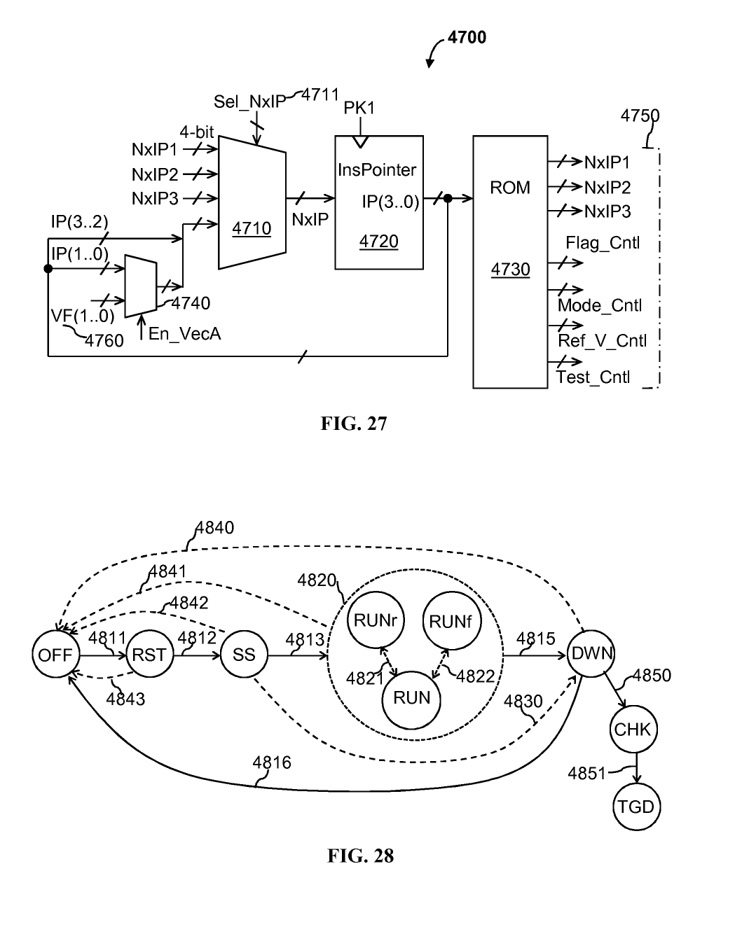

The uSTATE machine in FIG. 27 is a typical micro-programmed synchronous state machine which is made of an instruction pointer 4720, a ROM block 4730, and an array of multiplexers 4710, 4740. In the state machine, each state is defined by the instruction pointer address, and a micro instruction word read from ROM by the address defines specific controller functions in the state. Each micro-instruction word is divided into seven fields 4750: three next instruction pointer addresses, control signals setting operational modes, control signals for flag signal logic, control signals for digital reference voltage, and control signals for self-testing. In the uSTATE machine, the sequence of micro instructions to be accessed is determined by the next instruction addresses (NxIP1, NxIP2 and NxIP3) programmed in ROM and by the next address select signal Sel_NxIP(3 . . . 0) 4711 coming from the flag logic block.

FIG. 28 shows a typical state transition diagram of the synchronous uSTATE machine. In the diagram, OFF is obvious by itself. RST is a state resetting all the memory elements in the regulator for a clean start. SS is the soft-start operational mode in which the reference voltage is ramped up. Then there are three bundled running states (RUN, RUNr and RUNf) which are introduced in this controller design for dynamic control of reference voltage during the normal output voltage regulation. RUN is the state in which output voltage is regulated to a constant value. However, RUNr and RUNf are transitional states allowing ramping up and down the output voltage while doing the normal output voltage regulation. Finally DWN is to ramp down the reference voltage to zero for the soft turning-off. In addition to those normal operational states, two states are added for self-testing of the controller; CHK is to check its captured signature and TGD is to signal the test result.

In the state transition diagram, the machine can jumps from one state to one of three different states specified by three addresses from the instruction word. Or the machine can stay in the current state without jumping to other state. The transitions in FIG. 28 can be classified into three groups. The reset transitions (4840, 4841, 4842, 4843) are triggered by active critical flags forcing the regulator to turn off; The conditional transitions (4811, 4812, 4813, 4815, 4850, 4851) are triggered by the flags which are selected by the micro instruction word of the current state; and the transition 4830 from SS to DWN is a result of an active CL.

The uSTATE machine has a feature so called “vectored addressing” for additional state transitions. Under the vectored addressing scheme, the current IP address input to the address multiplexer is modified by two flag bits. In FIG. 27, a 2-bit multiplexer 4740 is used to replace the least significant 2-bit from IP by two flag bits VF(1 . . . 0) 4760. By doing so, the machine provides more flexible sequencing of instructions without much overhead. In the FIG. 28 state transition diagram, three bundled states (RUN, RUNr and RUN° are using the vectored addressing for transitions 4821, 4822 among the bundled states. In this controller design, the flag bits VF(1 . . . 0) are two signals (Go_Up and Go_Dn) from the reference voltage block indicating the direction of ramping reference voltage. If Go_Up is true, the machine jumps to RUNr ramping up the reference voltage. If Go_Dn is true, the machine jumps to RUNf ramping down the reference voltage.

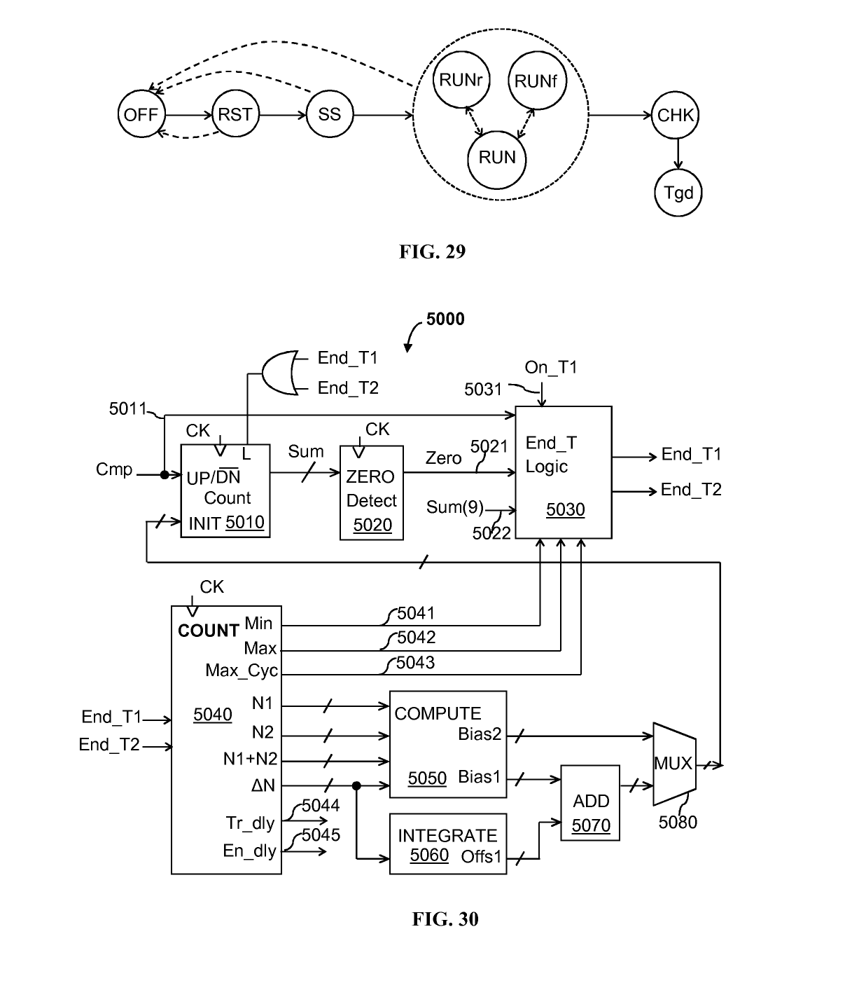

FIG. 29 shows a state transition diagram that is made by reprogramming the state transition diagram in FIG. 28. In the FIG. 29 diagram, two transitions 4815, 4830 in FIG. 27 are directed to OFF by changing the address fields in ROM, and the transition 4850 is pointed to CHK for the signature check. Because the uSTATE machine is micro-programmed, adding new operational modes and changing the operational sequence can be done by reprogramming micro instruction words in ROM.

The uSTATE machine is synced to the clock PK1 and the nSTATE machine is synced to the clock PK2. That sequential assignment of clocks guarantees that the controller operational mode is settled before the sampling clock is running and before any switch state changes.

Datapath

The datapath 5000 may be made of arrays of latches and computing logic gates which are laid out as a rectangular shaped block. In one side of the rectangular block, a narrow strip of control logics generates timing clocks and select signals, and conducts some random logic functions. The key function of a datapath is to process the timing pulse Cmp from a V/T comparator and generate two timing signals (End_T1 and End_T2) for the dual-edge centroid error tracking. In FIG. 30, the centroid tracking logic with a zero counter 5010 and a zero detector 5020 generates Zero 5021 to end T1 and T2 switching intervals. Then, the End_T logic 5030 evaluates the zero pulse and six additional signals, and generates End_T1 and End_T2. The six additional signals are Sum(9) 5022 which is the sign bit of Sum, Cmp 5011 from the V/T converter, On_T1 from the nSTATE machine, and Min 5041, Max 5042 and Max_Cyc 5043 from the counter block 5040. The End_T logic equations are:

End_{—}T1=On_{—}T1·(Max+Min· C̅m̅p̅·(Zero+Sum(9)))

End_{—}T2=Max_{—}cyc+ O̅n̅_̅{̅—̅}̅T̅1̅·(Max+Min·Cmp·(Zero+ S̅u̅m̅(̅9̅)̅))

In the equations, Zero indicates it is the end of an interval (T1 or T2) for the centroid error tracking. Then, other signals impose constraints on ending the switching interval and make the End_T1 and End_T2 signals count special operating conditions.

Max_Cyc indicates that (T1+T2) is over the maximum. Therefore it forces to end the current switching cycle. Max is to signal that the current interval is over the maximum. Min is to impose the minimum interval on T1 and T2. Cmp is another condition qualifying Zero and Sum(9). Sum(9) is the sign bit of Sum, and it is to count a case that Zero was true before Min.

In addition of modulating T1 and T2 for the centroid error tracking, the datapath counts N1, N2, N1+N2 and ΔN with the counter block 5040, and generates initial values for the zero counter 5010 through the compute block 5050 and the integrate block 5060. The digital integrator block 5060 accumulates ΔN, scales the accumulated value down and generates an offset value OFFS1 for one switching interval in order to cancel out the skew offset that is changing the switching period in one direction. And the compute block 5050 calculates BIAS1 and BIAS2 based on (N1, N2, N1+N2 and ΔN) for both switching intervals in order to regulate the switching period disturbance happened due to the dual-edge centroid error tracking process itself. Then, the MUX 5080 selects the sum of OFFS1 and BIAS1 for T1 initial value of the zero counter and BIAS2 for T2 initial value.

The compute block 5050 has to conduct arithmetic multiplication and division in order to calculate BIAS1 and BIAS2. In the design of this digital controller, both arithmetic operations are approximated.

Multiplications in ΔN·N1 and −ΔN·N2 may be done with an array of adders. First, ΔN is calculated and “bounded” to prevent arithmetic overflow in following operations. Then an absolute value of the bounded ΔN is used as a multiplier. The sign of ΔN is used as an input to XORs to make an absolute value of ΔN and to restore the sign of a result at the end of the multiplication.

Divisions

$$\frac{Δ N \cdot N 1}{N 1 + N 2} and \frac{Δ N \cdot N 2}{N 1 + N 2}$$

in may be approximated by bit-wise arithmetic shifting on the multiplication result. Therefore, it can only implement “divide by 2^{k}” through k-bit shifting where 2^{k}≈N1+N2.

The datapath may be designed to execute the dual-edge centroid error tracking method. If other tracking method is needed, then the datapath design can be reconfigured with minor logic changes, and it can do other chosen tracking method. Table 5 shows “End_T1” and “End_T2” logic equations for nine tracking methods.

TABLE 5

| Switching | Tracking | Tracking | |
|---|---|---|---|
| Period | Point | Edge | End_T1, End_T2 |
| Fixed | Centroid | T1 | End_T1 = On_T1 · Max + |
| Tsw = Nsw · Tck | | | On_T1 · Min · C̅m̅p̅ · (Zero + Sum(9)) |
| | | | End_T2 = Max_Cyc (which is Nsw · Tck) |
| | | T2 | End_T2 = On_T2 · Max + |
| | | | On_T2 · Min · Cmp · (Zero + S̅u̅m̅(̅9̅)̅) |
| | | | End_T1 = Max_Cyc (which is Nsw · Tck) |
| | Peak | T1 | End_T1 = On_T1 · Max + |
| | Or | | On_T1 · Min · C̅m̅p̅ |
| | Bottom | | End_T2 = Max_Cyc (which is Nsw · Tck) |
| | | T2 | End_T2 = On_T2 · Max + |
| | | | On_T2 · Min · Cmp |
| | | | End_T1 = Max_Cyc (which is Nsw · Tck) |
| Regulated ≈ | Centroid | T1, T2 | End_T1 = On_T1 · Max + |
| Nsw · Tck | | | On_T1 · Min · C̅m̅p̅ · (Zero + Sum(9)) |
| | | | End_T2 = Max_Cyc + On_T2 · Max + |
| | | | O̅n̅T̅1̅ · Min · Cmp · (Zero + S̅u̅m̅(̅9̅)̅) |
| | | T1 | End_T1 = On_T1 · Max + |
| | | | On_T1 · Min · C̅m̅p̅ · (Zero + Sum(9)) |
| | | | End_T2 = Max_Cyc + On_T2 · Max + |
| | | | O̅n̅T̅1̅ · Min · (Zero + S̅u̅m̅(̅9̅)̅) |
| | | T2 | End T1 = On_T1 · Max + |
| | | | On_T1 · Min · (Zero + Sum(9)) |
| | | | End_T2 = Max_Cyc + On_T2 · Max + |
| | | | O̅n̅T̅1̅ · Min · Cmp · (Zero + S̅u̅m̅(̅9̅)̅) |
| | Peak | T1 | End_T1 = On_T1 · Max + |
| | Or | | On_T1 · Min · C̅m̅p̅ |
| | Bottom | | End_T2 = Max_Cyc + On_T2 · Max + |
| | | | O̅n̅T̅1̅ · Min · (Zero + S̅u̅m̅(̅9̅)̅) |
| | | T2 | End_T1 = On_T1 · Max + |
| | | | On_T1 · Min · (Zero + Sum(9)) |
| | | | End_T2 = Max_Cyc + On_T2 · Max + |
| | | | O̅n̅T̅1̅ · Min · Cmp |

If a digital controller is designed to modify the “End_T1” and “End_T2” equations through micro instructions, then the controller is even able to change its error tracking method dynamically based on the operational mode for the optimal performance while doing the output voltage regulation.

Digital Reference Voltage Block

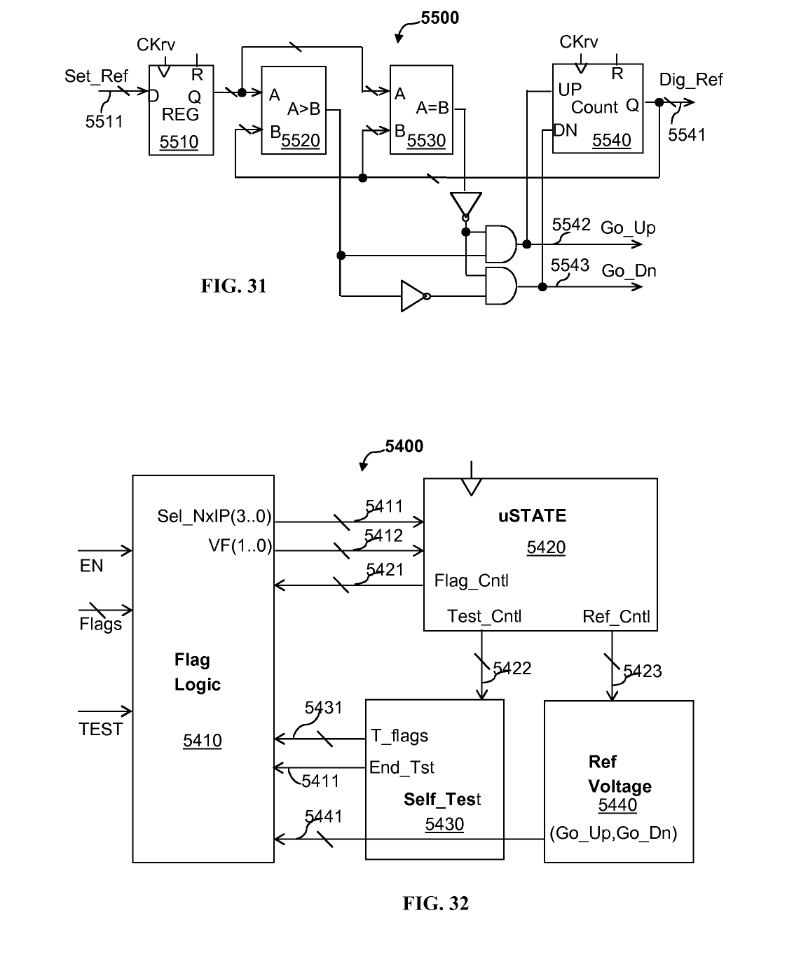

The digital reference voltage block is to generate digital reference voltage. In the switching regulators with this digital controller, the regulated output voltage can be ramped up or down, following the dynamic digital reference voltage which is set through a digital interface bus. FIG. 31 shows the digital reference voltage logic which is conducting the dynamic output voltage control. In the FIG. 31 design, there are two digital reference voltages. One is an absolute value that is held in a register 5510, and its value can be set to different values through a digital interface bus 5511. The other one is a temporal value held by an up/down counter 5540. This temporal digital reference value is sent to a D/A converter for analog reference voltage of the error amplifier in a V/T converter. Because the up/down counter is holding temporal reference voltage, the temporal voltage can count up or down to the absolute reference value. And that allows ramping up or down analog reference voltage for “soft-up” and “soft-down”. In order to control the up/down counter, the digital voltage comparator logics 5520, 5530 compare the temporal value to the absolute reference value. If the dynamic value is less than the absolute value, it activates the “Go_Up” flag 5542 and makes the counter increment. If the dynamic value is greater, the “Go_Dn” flag 5543 makes the counter decrement.

The Go_Up and Go_Dn flags are sent to the flag logic as shown in FIG. 32, and used for “vectored addressing” that is allowing the uSTATE machine to jump around three different states: “RUN”, “RUNr” and RUNf” in FIG. 28. This feature can be useful if the regulator requires a different preferred operational mode for each run state.

The datapath logics designed for the dual-edge centroid error tracking method may be reconfigured to implement any other error tracking methods as discussed below.

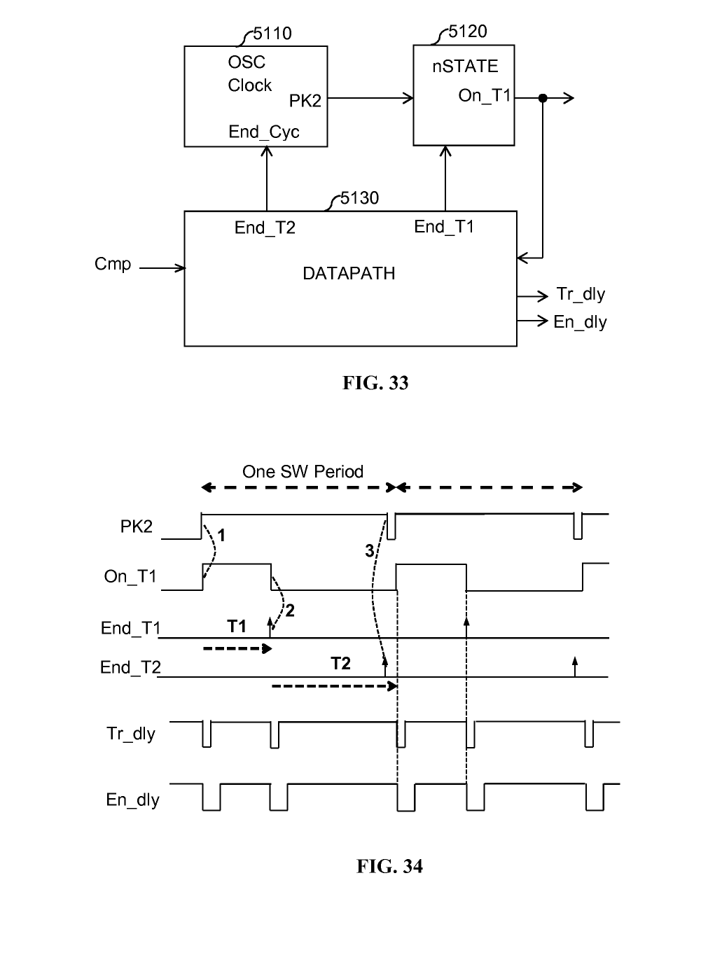

FIGS. 33-34 illustrate a series of timing events among three blocks (OSC/Clock, nSTATE, and datapath). A switching cycle is defined by a series of sequential timing events among the blocks, and T1 and T2 intervals are determined as the error tracking results of the datapath. First, each switching cycle is initiated by a reset signal “End_Cyc” to the OSC/Clock block 5110, which is “End_T2” from the datapath. The reset signal resets the switching cycle clock PK2 to low, and PK2 stays in low for next six oscillator clock cycles before it becomes high. Then, the rising edge of PK2 starts a switching cycle indicated at 1 in FIG. 34, and the nSTATE machine 5120 sets “On_T1” to high. Once On_T1 is high, the datapath 5130 counts “Cmp” from the V/T converter for the T1 error tracking, and signals “End_T1” to the nSTATE machine for resetting “On_T1” indicated at 2 in FIG. 34. Once On_T1 is low, the datapath starts a new counting for the T2 error tracking and signals “End_T2” to the OSC/Clock block for “End_Cyc” indicated at 3 in FIG. 34. However, the T2 interval continues next six oscillator clock cycles until PK2 begins a new switching cycle. A switching cycle is defined from a rising edge of PK2 to the next rising edge of PK2.

FIG. 34 also shows two useful timing signals for the regulators: Tr_Dly (non-overlapped delay during transitions) and En_Dly (enable signals for current sensing) from the datapath 5040 of FIG. 30.

Flag Signal Logic Block

The flag signal logic block provides an interface for flag signals to other blocks. There are many flag signals from various sensors in a switching regulator. First, the turning-on signal of a chip is an “enable chip” flag. Then there are flags warning exceptional events such like “over voltage protection”, “thermal shutdown”, and “under voltage lock-out”. And there are many more flags informing operational information to the regulator. Examples are “inductor current limit”, “zero inductor current”, “output voltage good” and “band-gap good”. Depending on a specific implementation, some of those sensors are outside of the controller chip.

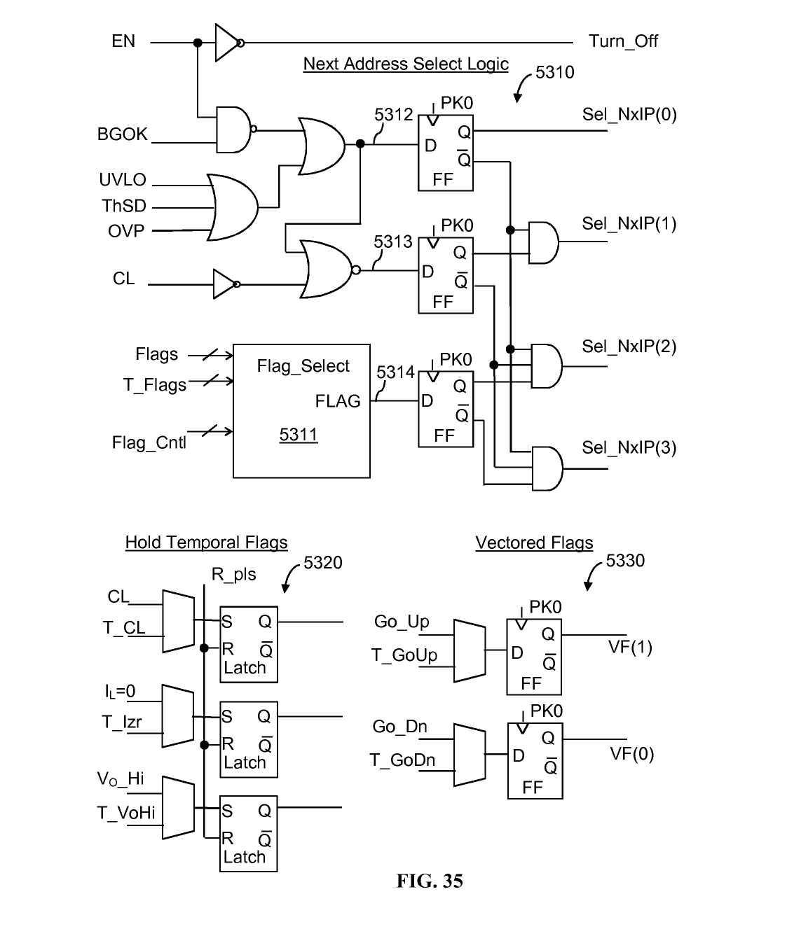

FIG. 35 shows three different usages of the flag signals. Three temporal flags 5320 are sampled and held for the nSTATE machine. Two flags 5330 from the reference voltage block are synchronized to PK0 and sent to the uSTATE machine for the 2-bit vector. Then, other flags are used to determine the next address selection signal Sel_NxIP(3 . . . 0) for the synchronous uSTATE machine in FIG. 27. In the FIG. 35 flag logic, critical event flags (EN, BGOK, UVLO, ThSD, OVP) are logically ORed for Sel_NxIP(0). An inductor current limit flag CL is used for Sel_NxIP(1). Then Sel_NxIP(2) is determined by flags that are selected by the current micro instruction. If any of those three address select bits is not high, then the default select bit Sel_NxIP(3) is set to high. There are hierarchies among active flag signals in the logic design 5310. Those flags setting Sel_NxIP(0) are served first and the flags for Sel_NxIP(2) are served last.

FIG. 32 shows how the flag signals affect the execution sequence of micro instructions. In the digital controller, the uSTATE machine 5420 sends the flag control signals 5421 to the flag logic 5410 in order to select specific flags to be evaluated in the current state. Then the flag logic generates the address select signal Sel_NxIP(3 . . . 0) 5411 based on the selected flags. In addition to the address select signal, the flag logic sends two flag bits VF(1 . . . 0) 5412 from the reference voltage block 5440 to the uSTATE machine to replace the least significant two bits of the current IP address for the vectored addressing.

If the controller is in the self-testing, the self-test block 5430 generates test pattern signals 5431, and the test signals replace the real flag signals in the flag logic block 5410 in order to control the testing sequence.

Self-Testing Logic Block

In some implementations, self-testing may be a useful feature the logical functions of the controller are too complex to be fully tested through a small number of test pads available in most controller chips. Fortunately, the controller is already providing basic constructs for the self-testing through signature analysis on the digital controller. Its synchronous micro-programmable uSTATE machine allows new test instructions to the micro instruction ROM and it also allows programming the micro instruction words for a sequence of self-testing operations. And test control signals from the micro instruction words can be used to control the testing functions.

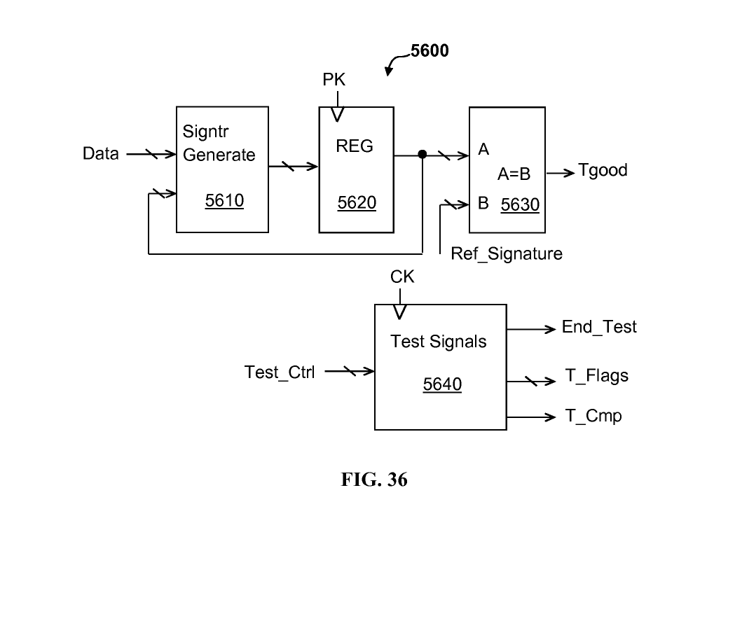

FIG. 36 is a block diagram of a self-test block. For the self-testing, the test signal block 5640 has to generate test patterns (signals to replace Cmp and Flags during self-test) under the direction of test control signals from the micro instruction words programmed in ROM. The most important test pattern is T_Cmp because the signal is processed through significant portion of digital logic gates in the digital controller. That is, the T_Cmp signal is processed by the zero counter, zero detection logic, and End_T logic for End_T1 and End_T2 signals. Then, the End_T1 and End_T2 signals determine N1, N2, N1+N2, and ΔN. At the end of a switching cycle, the initial value calculation logics use those numbers to get BIAS1, BIAS2 and OFFS1. On the other hand, other test flag signals direst the uSTATE machine to execute a predetermined sequence of micro instructions for the self-testing.

When the digital controller executes the predetermined self-testing operations with the test pattern signals, the signature generate block 5610 generates a new signature at the end of every switching cycle by doing “signature-capturing XOR operation” on the sampled input data and the current signature from the register 5620, then saves the new signature in the register until the test signal block 5640 signals End_Test. Then the captured signature is compared to the reference signature by the comparator 5630 for the test result (good or bad).

It is possible for the controller to do self-testing as a normal power-up operation.

Error Tracking Method

An error tracking method is a way of modulating power switching intervals (T1 and T2) based on error voltage signal and reference voltage signal. Aspects of the present disclosure include various error tracking methods that were not feasible before. That is accomplished by using the saw-tooth emulated current signal as dynamic reference voltage of the error comparator and by processing the comparator output timing pulse through digital logics designed for the error tracking.

In the embodiments of the present disclosure where the switching period is either fixed or regulated to one value, there are nine possible error tracking methods. In the embodiments of the present disclosure where one of the switching interval (T1 or T2) is either fixed or regulated to one value, eight additional error tracking methods may be designed.

Error Tracking Methods with Fixed Switching Period

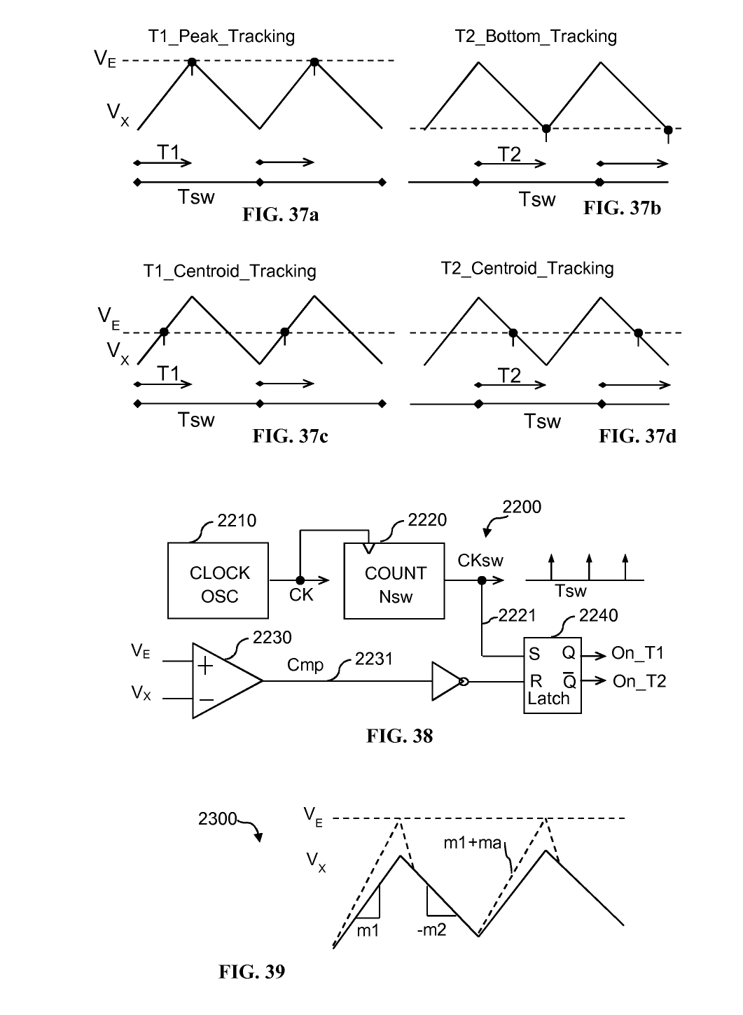

FIGS. 37a-37d21D show four error tracking methods where the switching period is fixed to one value Tsw. In these tracking methods, one switching interval (T1 or T2) is modulated for output voltage regulation and the other interval is determined by time left after the modulated interval.

T1 Peak Error Tracking Method with Fixed Tsw

FIG. 37a illustrates the peak error tracking method with a fixed switching period Tsw. In this tracking method, T1 is modulated so that error signal V_{E} meets the peak of rising V_{X} saw-tooth edges every time. Then T2 is defined by time left after T1.

FIG. 38 is a digital implementation of the peak tracking method. In the design, a binary counter 2220 generates the switching cycle clock CKsw 2221 by counting Nsw for the oscillator clock CK. Then a set/reset latch 2240 is set by CKsw to start a T1 interval and the latch is reset by the falling edge of the error comparator output Cmp to end the T1 interval. Then, the T2 interval is the time from the end of T1 to the next CKsw. Because the peak of rising saw-tooth edges hits error signal at the end of T1, it is called “T1 peak error tracking”.

For stability, this method needs “slope compensation” in FIG. 39. It is adding some portion of T2 saw-tooth slope to T1 slope through a slope compensation circuit.

T2 Bottom Error Tracking Method with Fixed Tsw

FIG. 37b is the bottom error tracking method with a fixed switching period. This method is almost same to the peak tracking method with two differences. First, it is modulating T2 such that the saw-tooth reference signal hits error signal at the bottom of falling edges. Then T1 is defined by time left after T2.

For stability, this method needs “slope compensation” that is adding some portion of T1 saw-tooth slope to T2 slope through a slope compensation circuit.

T1 Centroid Error Tracking Method with Fixed Tsw

FIG. 37c illustrates the T1 centroid error tracking method which has a fixed switching period. In this tracking method, T1 is modulated so that error signal crosses the center of rising saw-tooth edges. Then T2 is defined by time left after T1.

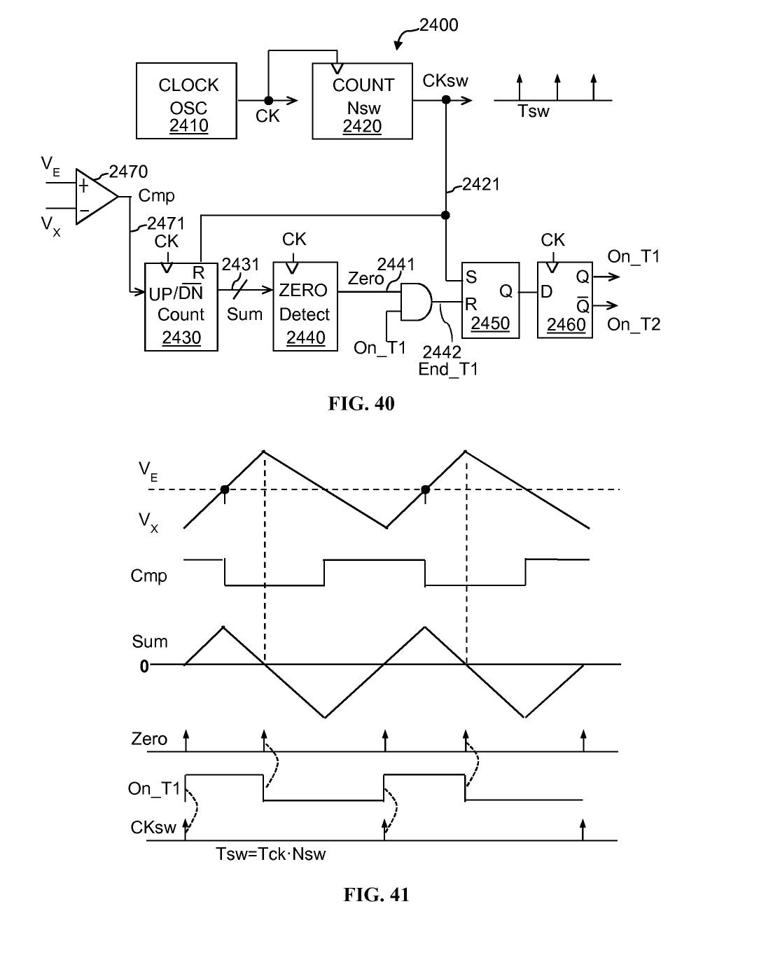

FIG. 40 is a digital implementation of the T1 centroid error tracking method. Key components in the design are an up/down counter 2430 and a zero detection logic 2440. For the centroid error tracking, the up/down counter is cleared at the beginning of each switching cycle by CKsw 2421. Then, each sampling cycle, the counter increments if the error comparator output Cmp 2471 is high, and decrements otherwise. Once its aggregated sum 2431 is zero, it generates a zero pulse 2441. It may generate two zero pulses in one switching cycle. In this T1 centroid tracking, a zero pulse during T1 ends the interval and the other zero is simply ignored.

FIG. 41 shows key signals of the T1 centroid tracking. Because “Zero” is the result of an aggregated sum of Cmp during T1, the falling edge of “Cmp” is aligned at the middle of T1, and that makes error voltage signal crosses the center of rising saw-tooth edges. This tracking method is called “centroid” instead of “centered”, because the zero pulse is a result of the aggregated sum of error comparator output.

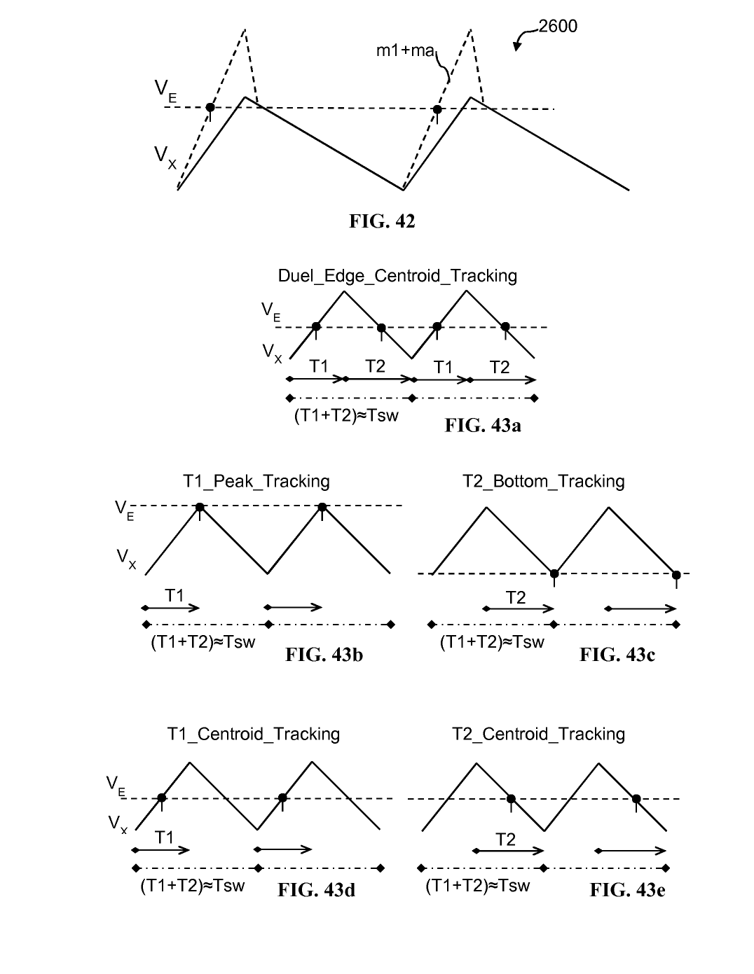

For stability, this method needs “slope compensation” in FIG. 42. It is adding some amount of T2 saw-tooth slope to T1 slope through a slope compensation circuit. Its compensation ratio has to be greater than one for a stable system.

T2 Centroid Error Tracking Method with Fixed Tsw

FIG. 37d is the T2 centroid error tracking method with a fixed switching period. This method is almost same to the T1 centroid tracking method with two differences. First, it is modulating T2 such that error signal V_{E} crosses saw-tooth reference signal V_{X} at the center of falling edges every time. Then T1 is defined by time left after T2.

For stability, this method needs “slope compensation” that is adding T1 saw-tooth slope to T2 slope through a slope compensation circuit.

Error Tracking Methods with Regulated Switching Period

FIGS. 43a-43e show five error tracking methods in which the switching period is a variable that has to be regulated to a predetermined number. Because the switching period is not fixed, it is possible either to modulate both intervals (T1 and T2) for error tacking or to modulate only one interval (T1 or T2) while using the other for switching period regulation.

Dual-Edge Centroid Error Tracking Method with Regulated (T1+T2)

FIG. 43a illustrates the dual-edge centroid error tracking method which is modulating both switching intervals for error tracking while regulating its switching period (T1+T2) to Tsw. In this tracking method, both T1 and T2 intervals are modulated so that error voltage signal crosses the center of both rising and falling saw-tooth edges. Because inductor current is adjusted two times in one switching cycle through T1 and T2 modulations, a switching regulator using this method responds two times faster to output voltage change when it is compared to the response of single edge tracking regulators. In this tracking method, adjustment of inductor current is done every switching interval, two times in a switching cycle.

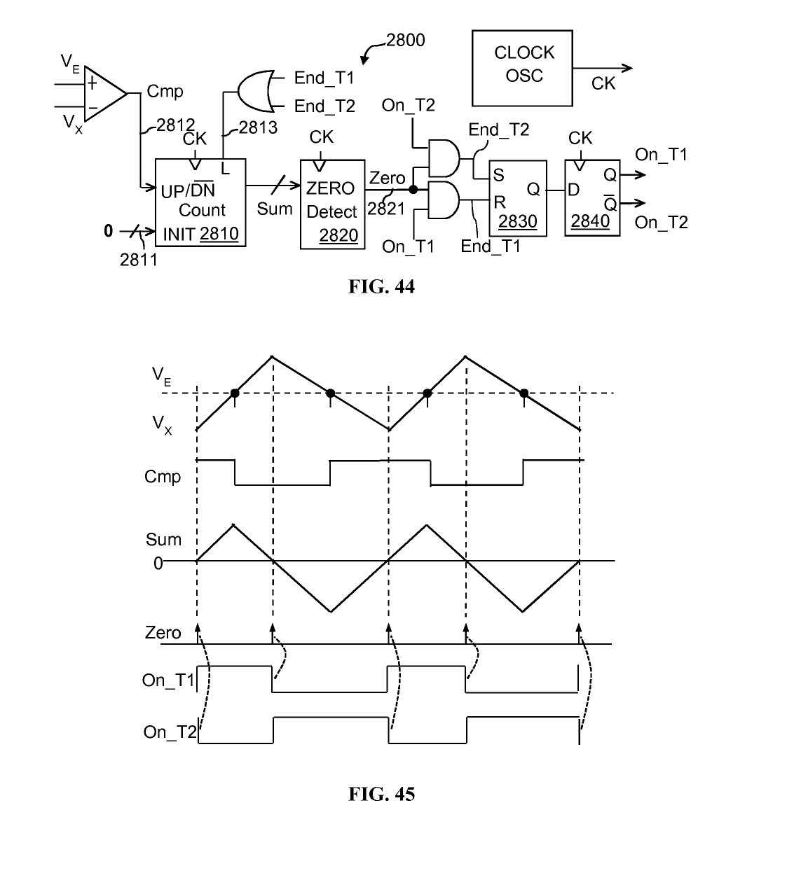

FIG. 44 is a digital implementation of the dual-edge centroid error tracking method and FIG. 45 illustrates the error tracking process with key signals. In the dual-edge tracking design, the zero counter 2810 is reset at the beginning of each switching interval and counts up or down for the error comparator output Cmp. Once the counter output Sum becomes zero, the zero detect logic 2820 generates a zero pulse to end the switching interval. In this dual-edge tracking method, error voltage signal V_{E} crosses both centroid points of rising and falling saw-tooth edges of the reference signal V_{X} for the output voltage regulation. However, there is no mechanism of defining its switching period in this bare-bone dual-edge centroid error tracking implementation. The switching period can be settled in any value as long as it is tracking the error signal by the centroid points of the saw-tooth reference signal.

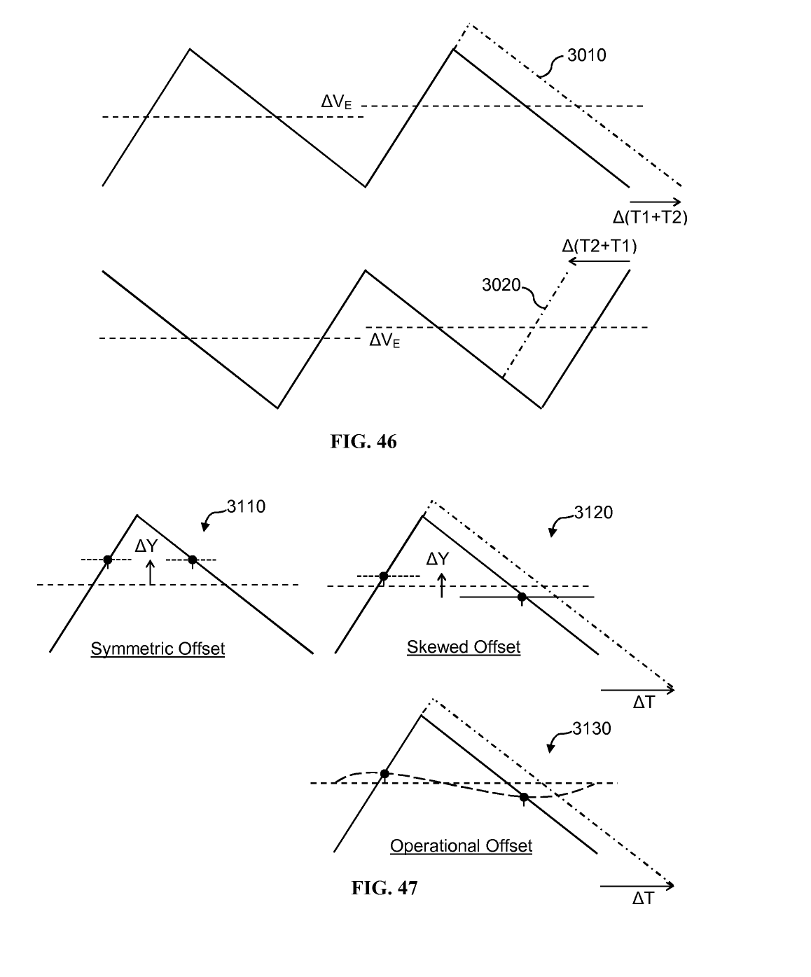

In the dual edge centroid tracking, its switching period (T1+T2) is changed if there is change in the error voltage signal. FIG. 46 shows two different ways that the switching period is affected by the same error voltage change ΔV_{E}. First, the error voltage ΔV_{E} during T1 raises V_{X} 3010 by 2ΔV_{E} and makes the switching period longer by

$$Δ T = 2 Δ {V}_{E} \cdot ( \frac{1}{m 1} + \frac{1}{m 2} )$$

where m1 and m2 are slopes in Table 3.

On the other hand, the error voltage ΔV_{E} during T2 shortens V_{X} 3020 by −2ΔV_{E} and makes the switching period shorter by

$$Δ T = - 2 Δ {V}_{E} \cdot ( \frac{1}{m 1} + \frac{1}{m 2} )$$

If the error voltage change ΔV_{E} is equally divided and applied to T1 and T2 intervals, then the switching period will not be changed because the effects on the switching period are canceling each other. However, V_{X} will be shifted up by ΔV_{E} and I_{L} will shifted up by

$$Δ {V}_{E} \cdot ( \frac{RxCx}{L} ) .$$

FIG. 47 shows different reasons of the switching period change in the dual-edge centroid tracking. In these cases, the error voltage signal is constant. However, centroid tracking points are in different voltage levels of rising and falling saw-tooth edges, and the skewed offset between two centroid points forces the centroid tracking process to keep increasing or decreasing its switching period. In the example shown at 3120, the centroid point of T1 is at a higher point than the T2 centoid point by ΔY, and that skewed offset increases the switching period every cycle by

$$Δ T = Δ Y \cdot ( \frac{1}{m 1} + \frac{1}{m 2} ) .$$

Because ΔT is linearly proportional to its skewed offset value ΔY and the skewed offset is a static parameter, the switching period is tend to change in one direction (increase or decrease) every switching cycle if there is no mechanism of regulating the switching period. In the LC switching regulators, the skewed offset can be happened due to non-ideal circuit parameters on the error amplifier, the error comparator and the V_{X} circuits. In addition, the error voltage signal V_{E} itself can create an operational skewed offset because V_{E} has asymmetric ripple as shown in 3130, and the operational skewed offset changes the switching period by the same way that the real skewed offset does.

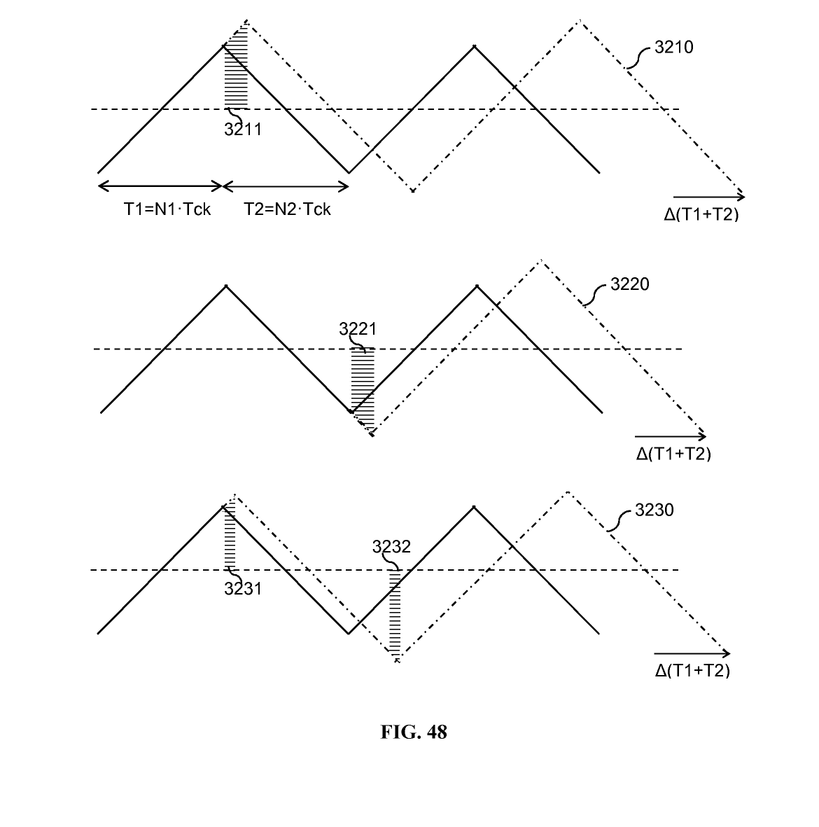

In the dual-edge centroid error tracking implementation in FIG. 44, a way of adjusting the switching period (T1+T2) is by setting initial values on the up/down zero counter 2810. FIG. 48 illustrates the switching period adjustments through the initial value set to the zero counter in the beginning of a switching interval. In the first example 3210, an initial value INIT1 is set to the zero counter, and that makes the zero counter to decrement additional INIT1 clock cycles before generating a zero pulse which is ending the T1 interval. Effect of INIT1 on the V_{X} signal is marked by a shaded area 3211. The T1 interval becomes longer by INIT1·Tck, and the switching period (T1+T2) becomes longer in the next cycle, by

$$Δ T = 2 \cdot INIT 1 \cdot ( 1 + \frac{m 1}{m 2} ) \cdot Tck$$

where m1 and m2 are slopes in Table 3.

In the second example 3220, an initial value “−INIT2” is set to the zero counter for T2, and the zero counter increments additional INIT2 clock cycles. That makes T2 longer by INIT2·Tck as marked by a shaded area 3221, and makes the switching period longer by

$$Δ T = 2 \cdot INIT 2 \cdot ( 1 + \frac{m 2}{m 1} ) \cdot Tck$$

An adverse side effect of the switching period adjustments is visualized by the shaded areas 3211, 3221. The shaded areas represent the unbalanced charge pumped by the inductor due to the switching interval adjustment (excess charging 3211 and excess discharging 3221). And that excess charging or discharging due to the switching period adjustment disturbs the switching regulator output voltage temporarily.

Let's represent T1, T2 and ΔT by integer numbers that the digital logic is processing for the centroid tracking. That is, N1=T1/Tck, N2=T2/Tck, ΔN=ΔT/Tck, Nsw=Tsw/Tck, and (N1+N2)=(T1+T2)/Tck. Then, in steady state, the equation

$$\frac{m 1}{m 2} = \frac{N 2}{N 1}$$

is true because the peak-to-peak voltage of V_{X} is same for falling and rising edges (m1·T1=m2·T2). And that allows to represent,

$$( 1 + \frac{m 2}{m 1} ) \approx ( 1 + \frac{N 1}{N 2} )$$

$$( 1 + \frac{m 1}{m 2} ) \approx ( 1 + \frac{N 2}{N 1} )$$

The slope parameters, m1 and m2, are actually not available to the digital logic for computation. The digital logic can count, sample/hold N1 and N2, determine the switching period disturbance by ΔN=Nsw−(N1+N2), and calculate the initial value that has to be set to the zero counter in order to adjust the disturbance ΔN in the next switching cycle.

There are three different ways to change the switching period by ΔN in the next switching cycle. First, it can be done by setting an initial value to the zero counter for one chosen switching interval:

$$INIT 1 = \frac{1}{2} \cdot Δ N \cdot ( \frac{N 1}{N 1 + N 2} )$$

### for T1, or

$$INIT 1 = - \frac{1}{2} \cdot Δ N \cdot ( \frac{N 2}{N 1 + N 2} )$$

### for T2

Or it can be done by setting initial values for both intervals,

$$INIT 1 = \frac{1}{4} \cdot Δ N \cdot ( \frac{N 1}{N 1 + N 2} )$$

### for T1, and

$$INIT 1 = - \frac{1}{4} \cdot Δ N \cdot ( \frac{N 2}{N 1 + N 2} )$$

### for T2.

An advantage of using both initial values for the switching period adjustment is that the output voltage disturbance due to the adjustment is somewhat reduced, because the areas shown in 3231 and 3232 are cancelling each other effect out.

On the other hand, an effective way to regulate the (T1+T2) disturbance due to the skewed offset is to introduce an intentional offset on the T1 centroid point (or on the T2 centroid point) through the initial value on the zero counter. If the intentional T1 offset is able to move its centroid point effectively to the same level of the T2 centroid point, then there is symmetric offset only (as shown in 3110) and the symmetric offset does not change (T1+T2). Because the skewed offset is tending to change (T1+T2) in one direction depending on the sign of skewed offset value, estimation of the initial value for the skewed offset cancellation can be done through a digital integrator working as a low frequency pass filter. The integrator generates an aggregated sum of ΔN=Nsw−(N1+N2), and the aggregated sum is scaled down and sent to the zero counter for an initial value which is cancelling the effect of the skewed offset. Once the offset canceling value matches to the real skewed offset, ΔN becomes zero, and the canceling value settles in a steady state value.

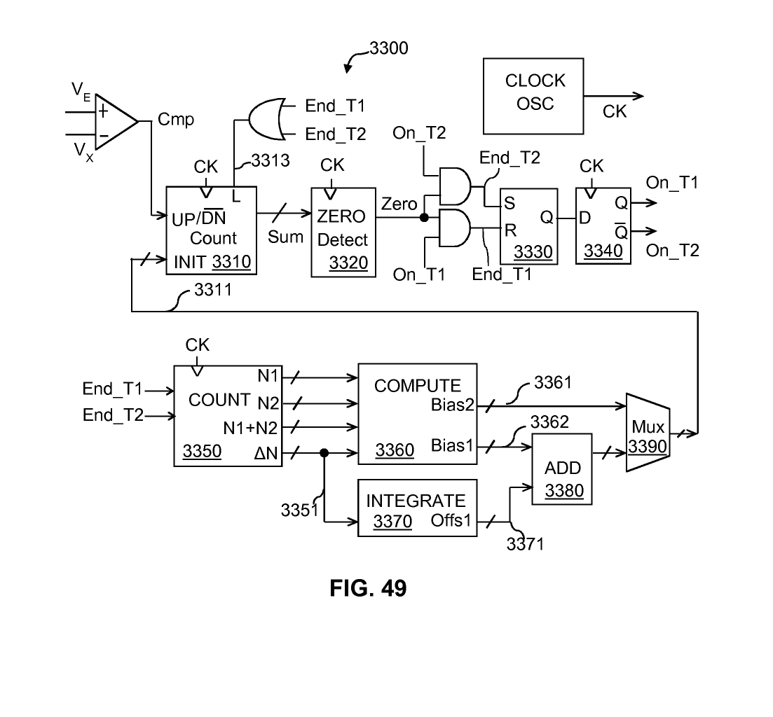

FIG. 49 is a digital implementation of the dual-edge centroid error tracking method, equipped with the logic blocks for the switching period (T1+T2) regulation. In the design, a count block 3350 generates N1, N2, N1+N2, and ΔN. Then, the initial values for the zero counter 3310 of the zero tracking logic are calculated through two different computation paths. The integrate block 3370 accumulates ΔN, scales the accumulated value down, and generates an offset value which is effectively moving the T1 centroid point to the same level of the T2 centroid point. And the compute block 3360 calculates

$$BIAS 1 = \frac{1}{4} \cdot Δ N \cdot ( \frac{N 1}{N 1 + N 2} ) and BIAS 2 = \frac{1}{4} \cdot Δ N \cdot ( \frac{N 2}{N 1 + N 2} )$$

in order to adjust (N1+N2) by ΔN by the end of next switching cycle. Then an adder 3380 and a multiplexer 3390 in FIG. 49 combines the offset and bias values, and generates (OFFS1+BIAS1) for the T1 initial value of the counter and BIAS2 for the T2 initial value.

T2 Centroid Error Tracking Method with Regulated (T1+T2)

FIG. 43e is the T2 centroid error tracking method with switching period regulation. In this tracking method, T2 interval is modulated for error voltage signal to cross the center of falling saw-tooth edges. And T1 interval is controlled so that the average switching period converges to Tsw.

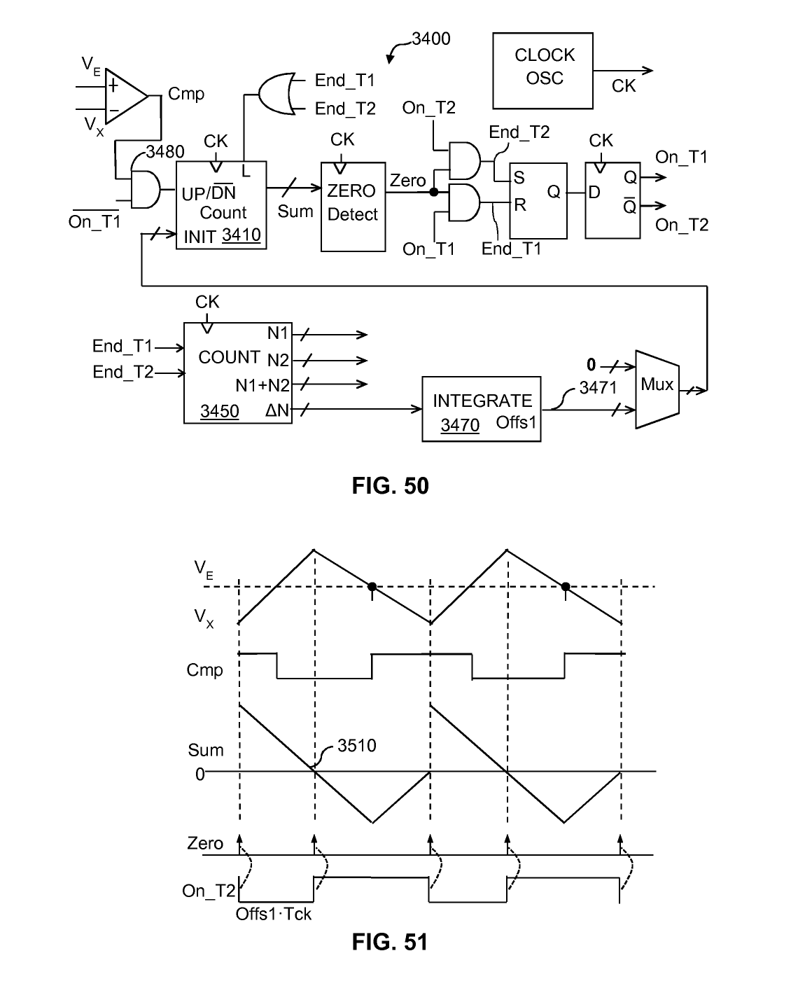

A digital implementation of this tracking method in FIG. 50 has a few changes from the dual-edge centroid tracking implementation. First, the bias calculation path is no longer needed. Then the error comparator output signal is set to low during T1 by logically ANDing O̅n̅_̅T̅1̅ and Cmp. That change makes that T1 is determined solely by the initial value of the zero counter which is now “OFFS1” from the ΔN integrator 3470. The counter is initialized by OFFS1 at the beginning of T1 and its output Sum decrements from OFFS1 to zero during T1 as shown in FIG. 51. That is,

T1=OFFS1·Tck

Then, T2 is determined by the centroid error tracking which is forcing the error signal V_{E} to cross the centroid point of falling saw-tooth edges of V_{X}. In the steady state, the peak-to-peak voltages of rising and falling saw-tooth edges of V_{X} are approximately same. Therefore, T2 and T1+T2 can be approximated by

$$T 2 \approx \frac{m 1}{m 2} \cdot T 1$$

where m1 and m2 are slopes from Table 3,

$$T 1 + T 2 \approx OFFS 1 \cdot ( 1 + \frac{m 1}{m 2} ) \cdot Tck$$

The switching period (T1+T2) is controlled by the T1 initial value “OFFS1” in the steady state. Once (T1+T2) converges to Tsw, ΔN converges to zero and OFFS1 is settled in a steady state value.

For stability, this method needs “slope compensation”. That can be done by increasing T2 saw-tooth slope slightly through a slope compensation circuit.

T1 Centroid Error Tracking Method with Regulated (T1+T2)

The T1 centroid error tracking method in FIG. 43d is a twin of the T2 centroid tracking method. Difference is that roles of T1 and T2 are exchanged. T1 is used for the centroid tracking and T2 is used to regulate the average switching period to Tsw. In this tracking method, the integrate block accumulates “−ΔN”, scales down the accumulated value to OFFS2 and sends it for a T2 initial value of the zero counter. The other change is that “Cmp” is forced to high during T2.

Therefore, during T2, the counter counts up from “OFFS2” until it becomes zero in order to determine the T2 interval.

For stability, this method needs “slope compensation”. That can be done by increasing T1 saw-tooth slope slightly with a slope compensation circuit.

T2 Bottom Error Tracking Method with Regulated (T1+T2)

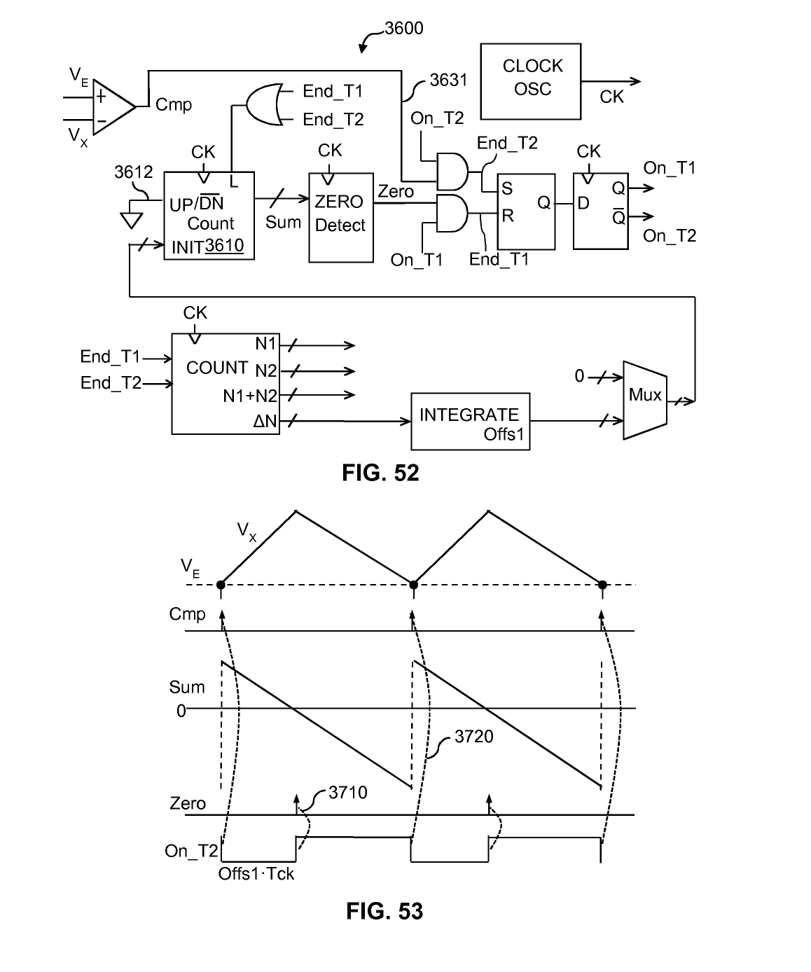

FIG. 43c is the T2 bottom error tracking method with switching period regulation. It is modulating T2 such that saw-tooth reference signal hits error signal at the bottom of falling edges and T1 is used to regulate the average switching period to Tsw. FIG. 52 is a digital implementation of the bottom tracking method.

In the implementation, the input of the zero counter is tied to low forcing the counter to count down from the initial value “OFFS1” which is calculated by the ΔN integrator. That is

T1=OFFS1·Tck

Then, T2 is determined by Cmp from the V/T converter (indicated at 3720) as shown in FIG. 53. And the switching period (T1+T2) is controlled by the T1 initial value “OFFS1”, as indicated at 3710. In the steady state,

$$T 1 + T 2 \approx OFFS 1 \cdot ( 1 + \frac{m 1}{m 2} ) \cdot Tck$$

Once (T1+T2) converges to Tsw, ΔN converges to zero and OFFS1 is settled in a steady state value.

This tracking method has no need of “slope compensation” for stability.

T1 Peak Tracking Method with Regulated (T1+T2)

The T1 peak error tracking method in FIG. 43b is a twin of the T2 bottom tracking method. Difference is that roles of T1 and T2 are exchanged. T1 is used for the peak tracking and T2 is used to set the average switching period to Tsw.

This tracking method has no need of “slope compensation” for stability.

Error Tracking Methods with One Fixed or Regulated Switching Interval (T1 or T2)

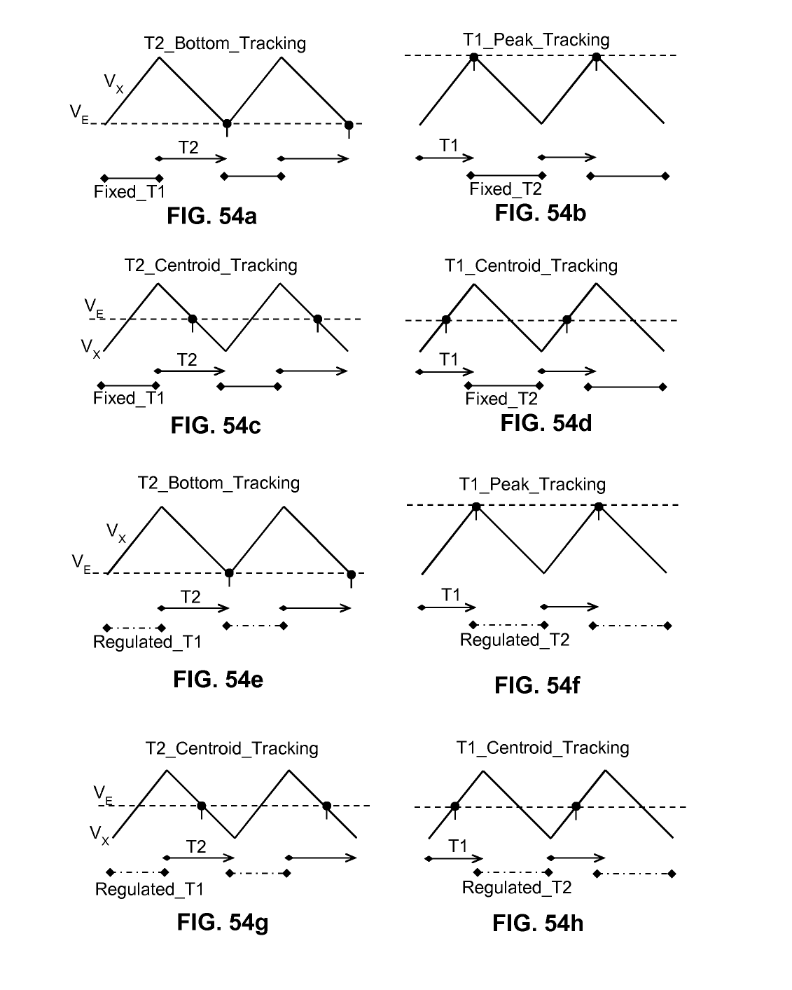

FIGS. 54a-54h show eight additional error tracking methods. In these tracking methods, one switching interval is either fixed or regulated to a predetermined number, and the other interval is used for the error tracking. In these tracking methods, the regulator switching period is a variable that has to be determined by input, output voltages of the regulator.

T2 Bottom Error Tracking with Fixed T1

FIG. 54a is the T2 bottom error tracking method with a fixed T1. In this tracking method, T1 is fixed to a predetermined value and T2 is modulated to track error signal V_{E} by the bottom of V_{X} falling edges.

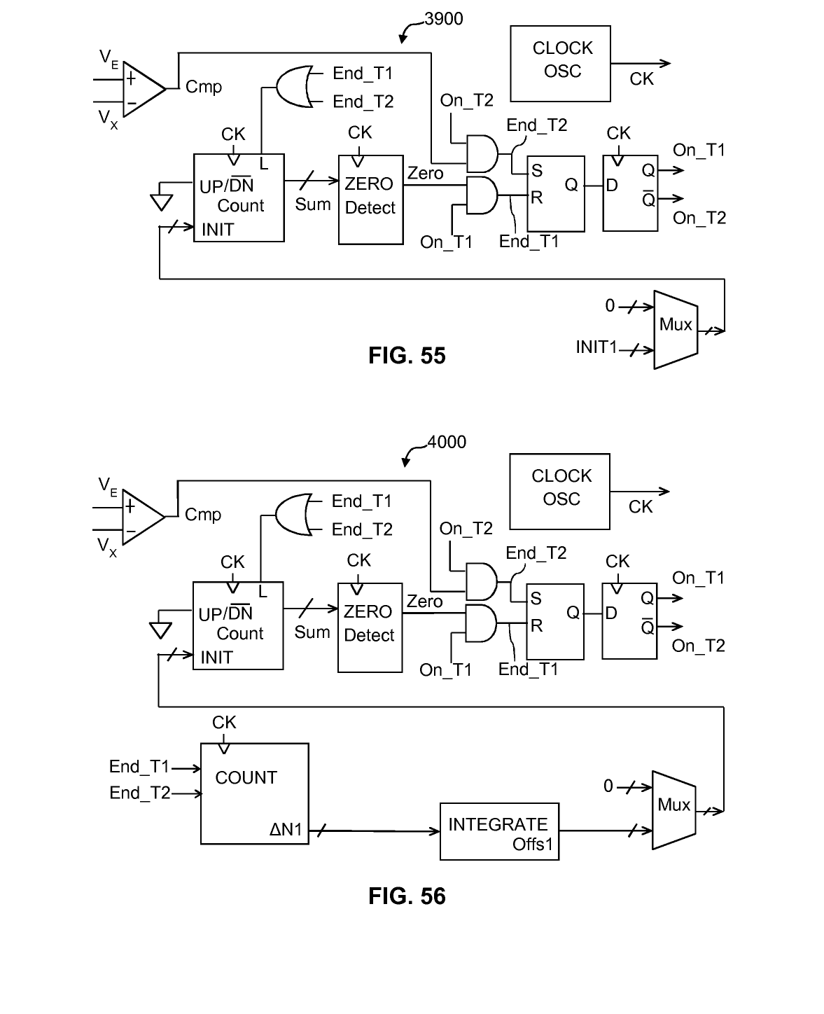

FIG. 55 is a digital implementation in which T1 is fixed by the initial value “INIT1” of the zero counter and T2 is ended by the rising edge of the error comparator output pulse Cmp.

In steady state,

$$T 1 + T 2 \approx INIT 1 \cdot ( 1 + \frac{m 1}{m 2} ) \cdot Tck$$

where m1 and m2 are from Table 3.

Because m1/m2 is a function of input and output voltages, the switching period (T1+T2) is determined by the T1 initial value INIT1 and the input/output voltages of the regulator.

T1 Peak Error Tracking with Fixed T2

This method in FIG. 54b is a twin of the T2 bottom tracking with a fixed T1. Roles of T1 and T2 are exchanged.

T2 Centroid Error Tracking with Fixed T1

FIG. 54c is the T2 centroid tracking method with a fixed T1. In this tracking method, T1 is fixed and T2 is determined by the T2 centroid error tracking.

In steady state,

$$T 1 + T 2 \approx INIT 1 \cdot ( 1 + \frac{m 1}{m 2} ) \cdot Tck .$$

T1 Centroid Error Tracking with Fixed T2

This method in FIG. 54d is a twin of the T2 centroid tracking with a fixed T1. Roles of T1 and T2 are exchanged.

T2 Bottom Error Tracking with Regulated T1

FIG. 54e is the T2 bottom error tracking method with a regulated T1. T1 is regulated to a predetermined value and T2 is tracking error signal by the bottom of falling edges.

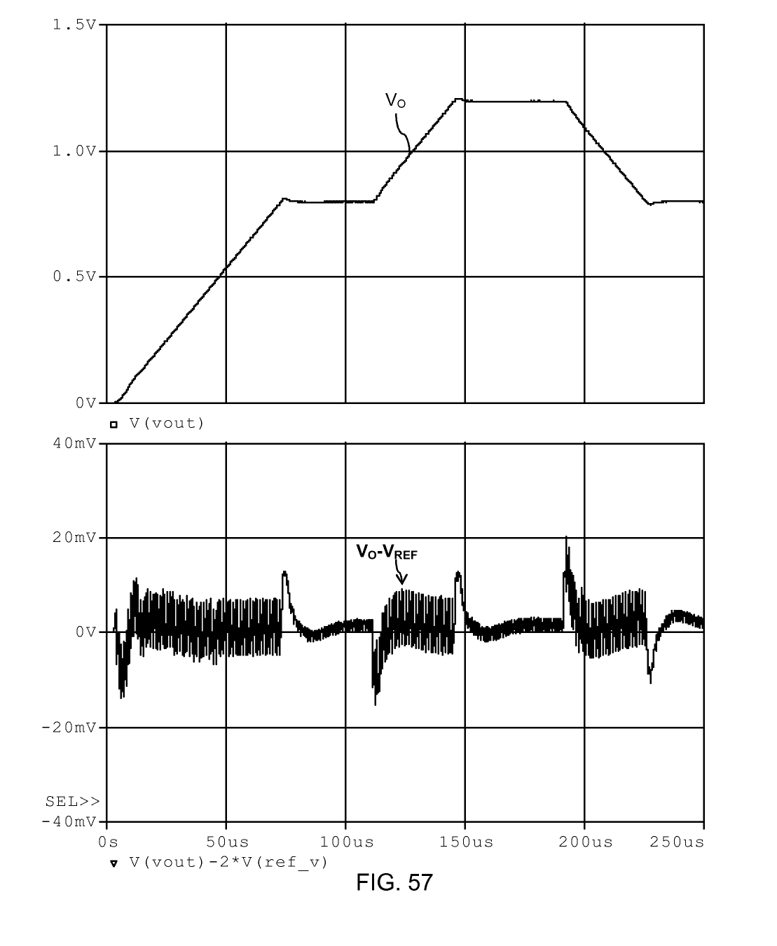

FIG. 56 is a digital implementation. In the implementation, the initial value for T1 is calculated through an integrator which is accumulating difference of T1 from a predetermined value. Then, T2 is determined by the rising edge of an error comparator output pulse. In steady state,

$$T 1 = OFFS 1 \cdot Tck$$

$$T 1 + T 2 \approx OFFS 1 \cdot ( 1 + \frac{m 1}{m 2} ) \cdot Tck$$

Once T1 converges to a pre-determined value, ΔN1 converges to zero, and OFFS1 is settled in a steady state value.

T1 Peak Error Tracking with Regulated T2

This method in FIG. 54f is a twin of the T2 bottom tracking with a regulated T1. Roles of T1 and T2 are exchanged.

T2 Centroid Error Tracking with Regulated T1

FIG. 54g is the T2 centroid tracking method with a regulated T1. In this method, T2 is tracking the error signal by its centroid point. And T1 is determined by an initial value of the zero counter. The initial value for T1 is calculated through an integrator adding difference of T1 from a predetermined value.

In steady state,

$$T 1 = OFFS 1 \cdot Tck$$

$$T 1 + T 2 \approx OFFS 1 \cdot ( 1 + \frac{m 1}{m 2} ) \cdot Tck$$

T1 Centroid Error Tracking with Regulated T2

This method in FIG. 54h is a twin of the T2 centroid tracking with a regulated T1. Roles of T1 and T2 are exchanged.

Simulations

Six LC switching regulators are designed with the V/T converter and the micro-programmed digital controller. And simulation results are presented to prove key design principles and to demonstrate performance of the new breed of LC switching regulators

Buck with Dual-Edge Centroid Error Tracking and Regulated (T1+T2)

FIG. 2a is the block diagram of a buck regulator which is performing the dual edge centroid tracking for output voltage regulation. The switching regulator is made of a V/T convertor and a digital controller which are surrounded by power switches, gate drivers, current sensor and A/D convertor. For the simulations of the buck regulator, circuits of the V/T converter are designed with typical 0.5 um mixed-signal CMOS device, and the power switches are also 0.5 um CMOS transistors. And the controller circuits are designed with basic Boolean logic gates (except the ring oscillator which is made of CMOS transistors). Then other components (gate driver, current sensor and A/D converter) are modeled by mathematical behaviors.

The regulator is assumed to be powered by one cell Lithium Ion battery and it is supposed to be used for hand-held devices. And the typical 0.5 um mixed-signal CMOS process is arbitrary chosen for the manufacturing process. After evaluating detailed analog and digital circuits with supply voltage down to 2.5V, following design parameters are chosen for the regulator: 1 MHz switching frequency, 256 MHz sampling clock frequency, and 10-bits wide datapath.

The analog and digital circuits designed with 0.5 um CMOS devices are fast enough to process 256 sampled data in 1 us cycle over the supply voltage range of one cell Lithium Ion battery. And the 10-bit datapath is wide enough to handle computation for the dual-edge centroid error tracking.

If the process technology is pushed down to the 0.18 um mixed-signal CMOS, then the switching frequency can be scaled up to 8 MHz and the sampling clock frequency can be to 2 GHz. In addition to faster clocks, V/T converter circuits will have more headroom to operate for the same supply voltage, and controller circuits will be fast enough to extend its datapath wider than 10 bits. Specially, the 0.18 um controller layout will be scaled down to ⅙ of the 0.5 um layout.

For the simulations, the buck regulator in FIG. 2a has a 2 uH inductor and a 18 uF capacitor for the LC output filter. Therefore its natural frequency is at 26.5 KHz, and the phase compensation zero is placed at 120 KHz by adjusting Cx and Rx in the emulated inductor current circuit.

FIG. 57 shows the regulator output voltage through a sequence of “soft-start”, “0.8V output”, “ramping up to 1.2V”, and “down to 0.8V”. For this simulation, a 20Ω resistor is connected to the output node, and the reference voltage is stepped up or down by 12 mV for 1 usec. Initially the digital reference voltage is set to a hexadecimal number “044” and then it is set to “066” at 110 usec to bring its output voltage up to 1.2V. And at 190 usec, the reference value is set to “044” for ramping down its output voltage back to 0.8V. The second plot in the figure shows how tight the output voltage is regulated during the dynamic reference voltage changes. It shows that the maximum output voltage error is within ±20 mV, about two times of the reference voltage step. The worst voltage error is over-shoot at the beginning of ramping down the reference voltage from 1.2V.

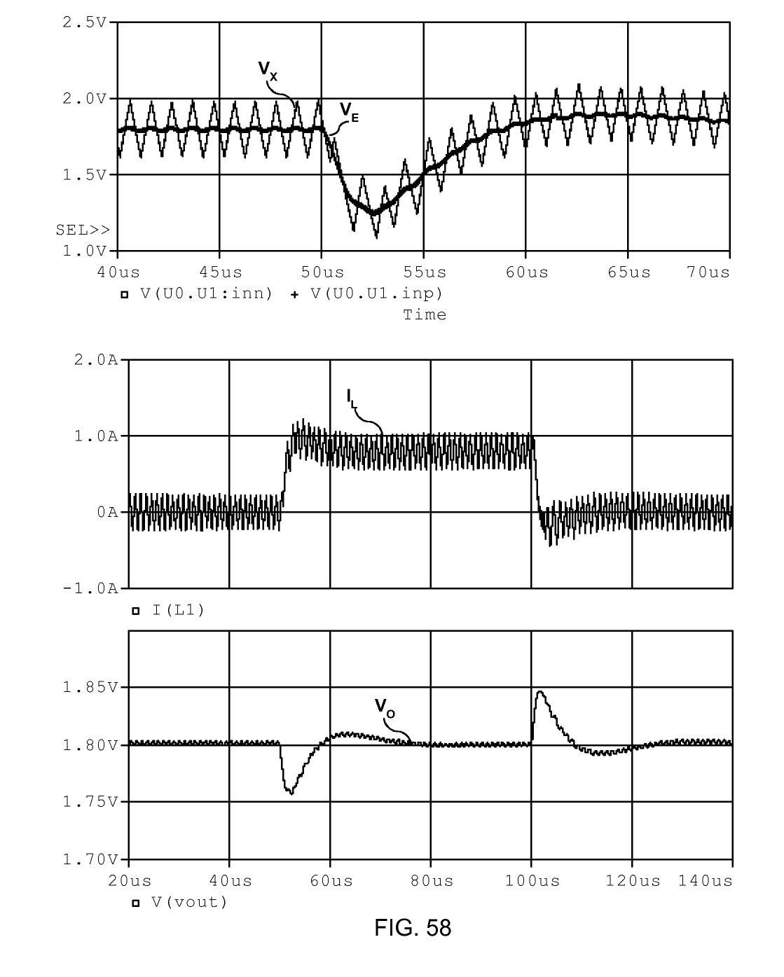

FIG. 58 is the transient response for the current pulse loading which is from OA to 0.8 A with 2 ns falling and rising time. The first plot in FIG. 58 shows the saw-tooth emulated inductor current signal V_{X} tracking the error signal V_{E} by its centroid points for the dual-edge error tracking while the output voltage is pulled down by the 0.8 A current pulse loading. The second and third plots show the inductor current and output voltage for the current pulse loading. FIG. 58 shows its output voltage error is within ±45 mV for the current pulse loading and the emulated current signal V_{X} swings between 1.2V and 2.3V. The inductor current waveform shows about ±0.2 A over and under shoot during transitions. The simulation results in FIG. 58 are prepared to compare the dual-edge centroid tracking regulator to regulators using other tracking methods.

Buck with T1 Peak Error Tracking and Fixed Tsw

This buck regulator has the same top-level schematic in FIG. 2a. Difference is that the error tracking method is changed in the datapath to do “T1 peak error tacking”. That is, the logic equations of “End_T1” and “End_T2” are modified as given in Table 5. However, all the control parameters are kept same except that the V_{X} T1 slope is modified by adding 58% of T2 slope for the slope compensation. This peak tracking regulator with fixed Tsw is comparable to the traditional buck regulator doing the pulse width modulation on T1. Differences are, first it is using the V/T converter for modulation and phase compensation, and secondly it is using the micro-programmed digital controller instead of the analog PWM and ad-hoc logic found in the traditional buck designs.

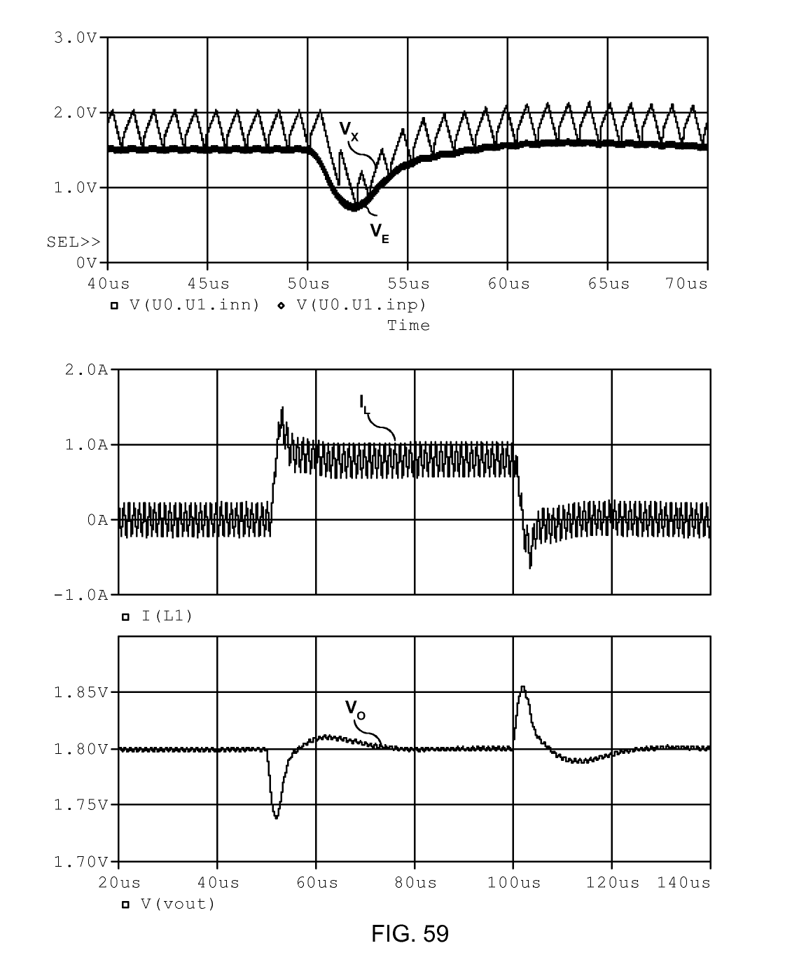

FIG. 59 shows transient responses of the peak tracking regulator. The plots are made in the same scale of FIG. 58 for easy comparison. One thing that can be noticed in FIG. 59 is that there is about 40% more output voltage error compared to voltage error in FIG. 58. The other thing is that the inductor current shows sharp peaks during transitions. Those are very much expected behaviors because the dual-edge tracking regulator is two times quicker in adjusting its inductor current for output voltage change than this single-edge peak tracking regulator.

Because V_{X} slope during T1 is falling in this implementation, it is actually doing “bottom tracking”. In the first plot of FIG. 59, the V_{X} saw-tooth reference signal hits the moving V_{E} error signal at the bottom. And in the beginning of T2, the V_{X} signal is pulled up fast about one third of the peak-to-peak voltage to remove charges which were injected for slope compensation during T1.

Buck with T1 Centroid Error Tracking and Fixed Tsw

This buck regulator conducts the T1 centroid error tracking while its switching period is fixed to a constant number. The “End_T1” and “End_T2” logics in the datapath are changed for this tracking method as given in Table 5.

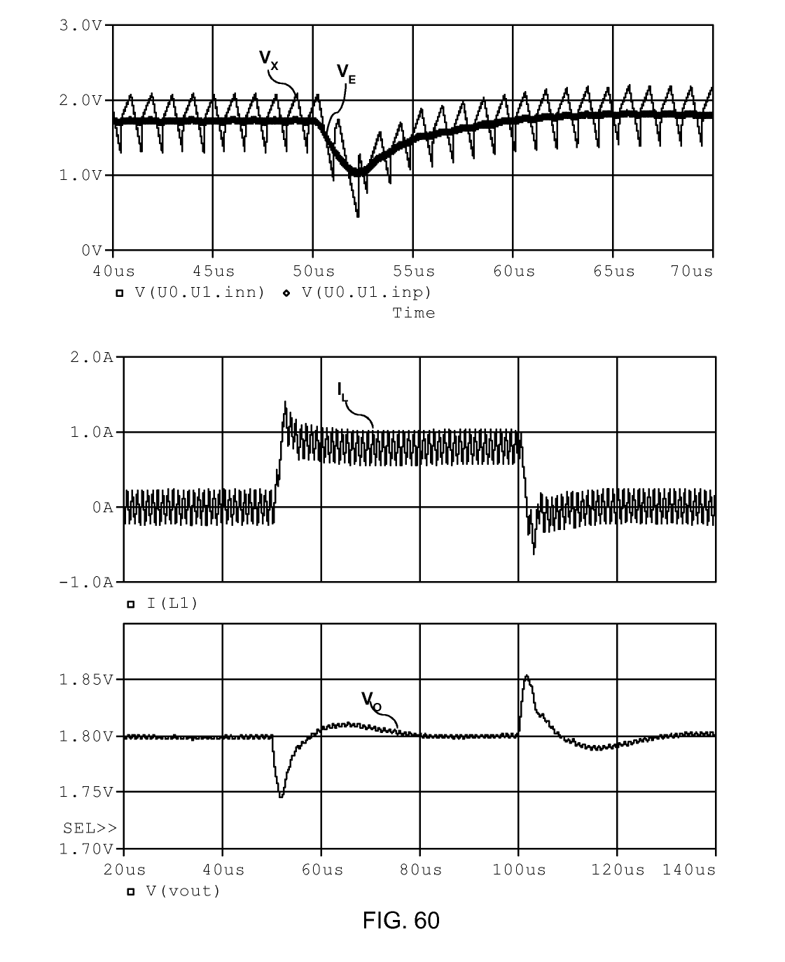

FIG. 60 is somewhat similar to the responses in FIG. 59. However these are less desirable when compared to FIG. 58 of the dual-edge centroid regulator. A key difference is on the latency for the regulator to adjust its inductor current for the output voltage change. In average, the single-edge tracking regulator has half cycle latency and the dual-edge tracking regulator has one quarter cycle latency.

In this implementation, the V_{X} T1 slope is modified by adding 115% of the T2 slope for the slope compensation. In the figure, the V_{X} signal is pulled up more than one half of the peak-to-peak voltage in the beginning of T2.

Buck with T2 Centroid Error Tracking and Regulated (T1+T2)

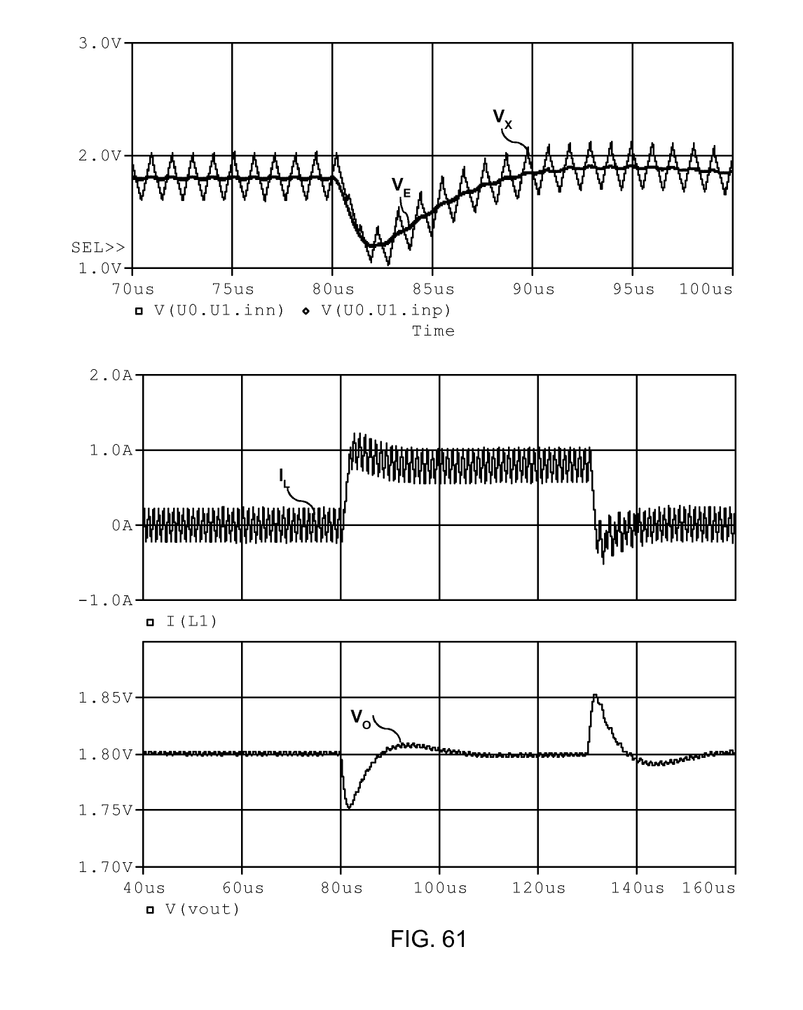

FIG. 61 shows transient responses of the T2 centroid tracking regulator which is regulating T1 for the switching period (T1+T2) to converge to Tsw slowly. When this regulator is compared to the dual-edge centroid tracking regulator and the single-edge tracking, fixed Tsw regulators, its performance lies between the dual-edge tracking regulator and the single-edge tracking, fixed Tsw regulators.

For falling output voltage, this regulator is very effective as shown in FIG. 61. Its switching frequency is determined by sum of T1 (which is rather constant during this fast transition) and the minimum T2 due to the fast falling output voltage. That is, the switching frequency is about two times of its steady state value temporarily during the falling transition. And it is shown in a zoomed-in plot of the figure. That makes this regulator perform like the dual edge centroid tracking regulator.

This regulator needs slope compensation for stability. In this implementation, the T2 slope is raised about 16% from its original T2 slope. In the zoomed-in plot of FIG. 61, T1 slope is pulled down in the beginning in order to remove charges injected for the slope compensation during T2.

Boost with dual-Edge Centroid Error Tracking and Regulated (T1+T2)

FIG. 2b is the block diagram of a boost regulator which is performing the dual-edge centroid tracking for output voltage regulation. This boost regulator is using the same V/T converter and digital controller designed for the buck regulator with some changes. In the V/T converter, the V_{X} circuit is modified for the switch setting of a booster as given in Table 4. Then, in the digital controller, the nSTATE logic is changed to handle the “current limit” differently. In this boost design, the current limit flag is logically ORed with “End_T1”. Therefore, an active CL flag causes the controller to end its T1 and jump to T2. In this booster, a low-side NMOS transistor and a Schottky diode are used for the power switches.

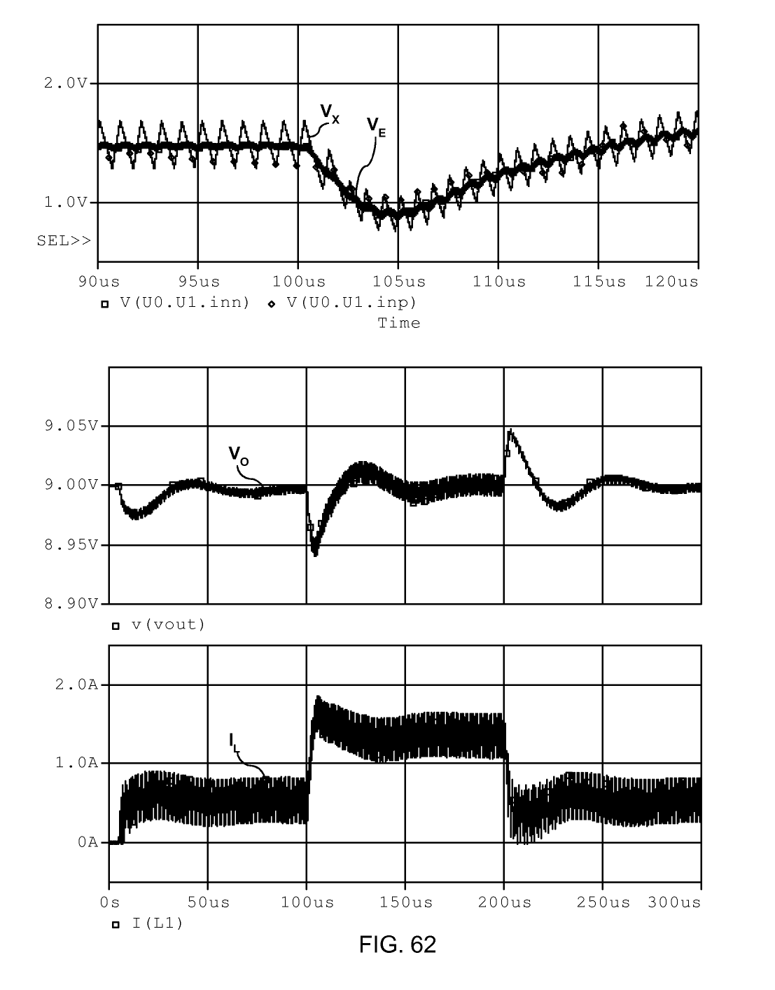

To improve stability, a feed-forward capacitor is connected in parallel with a voltage divider resistor of the feedback path in the FIG. 2b schematic. And the boost regulator has a 4 uH inductor and a 18 uF capacitor for the output LC filter. FIG. 62 is transient responses of the 9V booster for 0.2 A-to-0.5V current pulse load. In general the response shows that the booster is reasonably stable. However it is less stable compared to the buck regulators as expected. The first plot of FIG. 62 is a zoomed-in plot during a transition. It shows that V_{X} is tracking V_{E} by its center, and it also shows the switching period varying during the transition.

Buck-Boost with Dual-Edge Centroid Error Tracking and Regulated (T1+T2)

FIG. 2c is a block diagram of a non-inverting buck-boost regulator which is performing the dual-edge centroid tracking for output voltage regulation. In this regulator, the switch driver block generates three signals for power switches and the current sensor block senses “inductor current limit” during T1 and “inductor zero current” during T2. A Schottky diode is connected between the switching node and output node to pump inductor current to output capacitor during T2. For improved stability, the buck-boost regulator has a feed-forward capacitor in the output voltage divider. In the simulation schematic, L=4 uH and C=18 uF are used for the output filter.

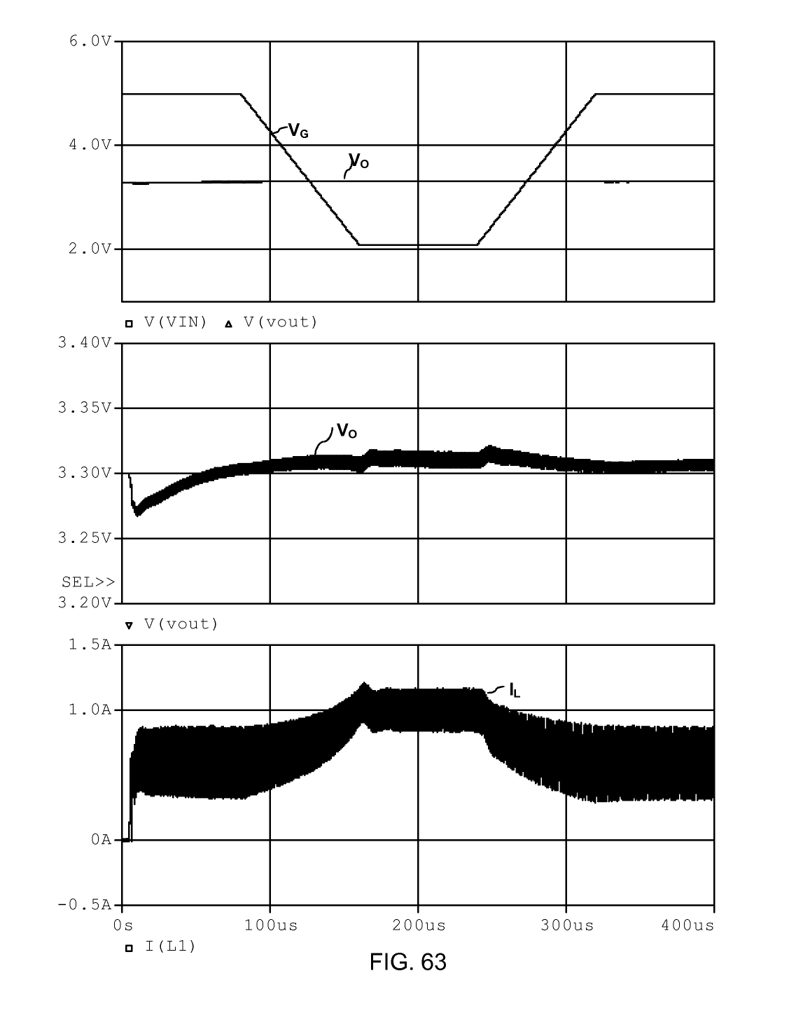

FIG. 63 is a transient response of the buck-boost regulator. In the simulation, its output voltage is set to 3.3V and the input voltage is ramped down from 5V to 2.1V, and ramped up to 5V, making the regulator operate as a buck and as a booster.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims. Additionally, in the claims that follow, the indefinite article “a”, or “an” when used in claims containing an open-ended transitional phrase, such as “comprising,” refers to a quantity of one or more of the item following the article, except where expressly stated otherwise. Furthermore, the later use of the word “said” or “the” to refer back to the same claim term does not change this meaning, but simply re-invokes that non-singular meaning. The appended claims are not to be interpreted as including means-plus-function limitations or step-plus-function limitations, unless such a limitation is explicitly recited in a given claim using the phrase “means for” or “step for.

What is claimed is:

1. A switching regulator for use in a circuit having an inductor and one or more switches that control charges applied to the inductor from an input voltage source, the switching regulator comprising:
an error amplifier configured to generate an error voltage signal by amplifying a difference between a feedback voltage and a reference voltage, wherein the feedback voltage is corresponding to an output voltage of the switching regulator;
an inductor current emulation circuit configured to generate an emulated inductor current signal that emulates an inductor current that flows through the inductor, wherein the emulated inductor current signal is generated from an input voltage of the switching regulator, the output voltage and first and second switching intervals T1 and T2 of at least one of the one or more switches;
an error voltage comparator configured to generate a timing pulse signal by comparing the error voltage signal to the emulated inductor current signal, wherein the timing pulse signal carries information of a relative error voltage level against rising and falling saw-tooth edges of the emulated inductor current signal; and
a controller configured to modulate at least one of the switching intervals of the switches by control signals generated based on the timing pulse signal.

2. The switching regulator of claim 1 further comprising a slope compensation circuit configured to change a slope for either falling or rising saw-tooth edge of the emulated inductor current signal or the error voltage signal, wherein the slope compensation circuit is coupled to an output node of the inductor current emulation circuit or coupled to an output node of the error amplifier wherein a slope of an emulated inductor current saw-tooth signal edge is increased by adding a portion of a slope of a following saw-tooth edge, and an effect of increased slope on the emulated inductor current signal is removed from the emulated inductor current signal in a following switching interval.

3. The switching regulator of claim 1, wherein the emulated inductor current signal generates a phase-compensation zero in a feedback control loop.

4. The switching regulator of claim 1, wherein the inductor current emulation circuit comprises two current sources, two current switches respectively controlling the current sources, and a RC network connecting to the current sources through the corresponding current switches, wherein the two current switches are controlled by timing signals based on switching intervals of the two current switches so that a capacitor voltage signal of the RC network emulates an inductor current signal waveform of the switching regulator.

5. The switching regulator of claim 4, wherein the RC network is configured to be a current-integrating capacitor in a frequency higher than a natural frequency of the switching regulator and configured to suppress the emulated inductor current signal in a low frequency spectrum.

6. The switching regulator of claim 1, wherein the error voltage comparator comprises a first differential input voltage comparator configured to operate in a high input voltage range, a second differential input voltage comparator configured to operate in a low input voltage range, and a third voltage comparator configured to determine an operating range of the error voltage signal and configured to enable the first or the second differential input voltage comparators depending on the operating range of the error voltage signal, wherein an output signal from the enabled differential input voltage comparator is output as the timing pulse signal.

7. The switching regulator of claim 1, wherein the controller comprises:
an oscillator and clock generator configured to generate clock signals, wherein the generator can be stopped or resumed for its oscillation;
a first state machine configured to control on/off states of the switches and configured to control the oscillator and clock generator;
a second state machine configured to execute a sequence of instructions in response to flag signals to direct the switching regulator through a sequence of operational modes;
a datapath configured to generate end signals to end the switching intervals of the switches;
a digital reference voltage circuit configured to generate the reference voltage and configured to ramp up or ramp down the reference voltage; and
a flag logic circuit configured to interface flag signals to other circuits in the controller.

8. The switching regulator of claim 1, wherein the controller configured to modulate both the first and second switching intervals (T1 and T2) based on the timing pulse signal wherein the error voltage signal crosses a centroid point of the rising and falling saw-tooth edge of the emulated inductor current signal in each switching interval and wherein a switching period which equals to T1+T2 is regulated.

9. The switching regulator of claim 1, wherein the controller modulates the first switching interval T1 based on the timing pulse signal wherein the error voltage signal meets a peak of the rising saw-tooth edge of the emulated inductor current signal in the first switching interval T1.

10. The switching regulator of claim 1, wherein the controller modulates the second switching interval T2 based on the timing pulse signal wherein the error voltage signal meets the emulated inductor current signal at a bottom of the falling saw-tooth edge in the second switching interval T2.

11. The switching regulator of claim 1, wherein the controller modulates the first switching interval T1 based on the timing pulse signal wherein the error voltage signal crosses a centroid point of the rising saw-tooth edge of the emulated inductor current signal in the first switching interval T1.

12. The switching regulator of claim 1, wherein the controller modulates the second switching interval T2 based on the timing pulse signal wherein the error voltage signal crosses a centroid point of the falling saw-tooth edge of the emulated inductor current signal in the second switching interval T2.

13. The switching regulator of claim 9, 10, 11 or 12, wherein a switching period which equals T1+T2 is regulated or fixed.

14. The switching regulator of claim 9 or 10, wherein the second switching interval T2 is fixed or regulated.

15. The switching regulator of claim 10 or 12, wherein the first switching interval T1 is fixed or regulated.

16. An error tracking method for a switching regulator for a circuit having an inductor and one or more switches that control charges applied to the inductor from an input voltage source, comprising:
generating an error voltage signal by amplifying a difference between a feedback signal and a reference signal, wherein the feedback signal is corresponding to an output signal of the switching regulator;
generating an emulated inductor current signal that emulates an inductor current that flows through an output inductor in the switching regulator, wherein the emulated inductor current signal is generated from an input voltage and an output voltage of the switching regulator, and first and second switching intervals T1 and T2 of at least one of the one or more switches;
generating a timing pulse signal by comparing the error voltage signal to the emulated inductor current signal, wherein the timing pulse signal carries information of a relative error voltage level against rising and falling saw-tooth edges of the emulated inductor current signal; and
modulating at least one switching intervals of the switches based on the timing pulse signal.

17. The method of claim 16, wherein the step of modulating comprises modulating both the first and second switching intervals T1 and T2 based on the timing pulse signal, wherein the error voltage signal crosses a centroid point of the rising and falling saw-tooth edge of the emulated inductor current signal in each switching interval and wherein a switching period which equals T1+T2 is regulated.

18. The method of claim 16, wherein the step of modulating comprises modulating the first switching interval T1 based on the timing pulse signal wherein the error voltage signal meets a peak of the rising saw-tooth edge of the emulated inductor current signal in the first switching interval T1.

19. The method of claim 16, wherein the step of modulating comprises modulating the second switching interval T2 based on the timing pulse signal wherein the error voltage signal meets the emulated inductor current signal at a bottom of the falling saw-tooth edge in the second switching interval T2.

20. The method of claim 16, wherein the step of modulating comprises modulating the first switching interval T1 based on the timing pulse signal wherein the error voltage signal crosses a centroid point of the rising saw-tooth edge of the emulated inductor current signal in the first switching interval T1.

21. The method of claim 16, wherein the step of modulating comprises modulating the second switching interval T2 based on the timing pulse signal wherein the error voltage signal crosses a centroid point of the falling saw-tooth edge of the emulated inductor current signal in the second switching interval T2.

22. The switching regulator of claim 18, 19, 20 or 21, wherein a switching period equal to T1+T2 is regulated or fixed.

23. The switching regulator of claim 18 or 20, wherein the second switching interval T2 is fixed or regulated.

24. The switching regulator of claim 19 or 21, wherein the second switching interval T1 is fixed or regulated.
